(19) United States
(12) Patent Application Publication
(10) Pub. No.: US 2024/0132386 A1
(43) Pub. Date: Apr. 25, 2024

(54) WATER PURIFIER

(71) Applicant: COWAY Co., Ltd., Gongju-si (KR)

(72) Inventors: Si Jun PARK, Gongju-si (KR); Hyun Suk MOON, Gongju-si (KR); Sang-Young LEE, Gongju-si (KR); Doo Won HAN, Gongju-si (KR); Jung Chul PARK, Gongju-si (KR); In Du CHOI, Gongju-si (KR)

(73) Assignee: COWAY Co., Ltd., Gongju-si (KR)

(21) Appl. No.: 18/485,350

(22) Filed: Oct. 12, 2023

(30) Foreign Application Priority Data
Oct. 12, 2022 (KR) 10-2022-0130625
Oct. 12, 2022 (KR) 10-2022-0130627

(51) Int. Cl. C02F 5/08; C02F 1/00

(52) U.S. Cl. CPC C02F 5/08; C02F 1/001; C02F 1/008; C02F 1/44

(57) ABSTRACT

The present invention relates to a water treatment device, and more specifically to a water purifier capable of removing scale in a simple manner. A water purifier according to one aspect of the present invention includes: a body casing; a raw water flow path unit provided in the body casing and through which introduced raw water flows; a filtration unit for filtering the raw water to generate purified water; a purified water flow path unit through which the purified water flows; a purified water outlet flow path unit through which the purified water flows to be discharged to the outside; a water outlet unit detachably coupled to the body casing, connected to the purified water outlet flow path unit, and provided with a drinking water outlet to allow the purified water to be discharged to the outside; a descaling kit unit detachably coupled to the body casing so as to be replaceable with the water outlet unit and provided with an internal flow path to allow washing water to flow to the purified water flow path unit, wherein the washing water is generated by dissolving a descaling material in the purified water introduced through the purified water outlet flow path unit; and a control unit for controlling fluid flow in each of the units.

### CROSS-REFERENCE TO RELATED APPLICATION

This application claims priority to and the benefit of Korean Patent Application No. 10-2022-0130627, filed on Oct. 12, 2022, and Korean Patent Application No. 10-2022-0130625, filed on Oct. 12, 2022, the disclosure of which is incorporated herein by reference in its entirety.

### TECHNICAL FIELD

The present invention relates to a water treatment device, and more specifically to a water purifier capable of removing scale in a simple manner.

### BACKGROUND ART

In general, a water purifier is a device that filters obtained raw water into drinkable purified water and provides it to a user. In addition, the water purifier may also heat or cool the filtered purified water to generate hot water or cold water and then provide it to the user. However, when the water purifier is used for a long period of time, foreign substances such as scale are generated in the flow paths through which the purified water, hot water and cold water flow, and such scale causes a problem that the cleanliness of drinking water provided to the user is reduced.

A conventional water purifier disclosed in Korean Patent Laid-Open Publication No. 2011-0094172 filed by LG Electronics Co., Ltd. is equipped with a water tank unit including a storage tank, a cold water tank, and a hot water tank. This water purifier uses two methods to generate cleaning water. The first method is to generate cleaning water by injecting a cleaning agent into the water tank unit where the purified water is stored, and to use the cleaning water to clean the water tank unit. However, when cleaning the water tank unit in this way, there is a problem that it is difficult to remove the scale generated on the flow path through which the purified water, hot water and cold water flow. In addition, since the cleaning process is completed by injecting the cleaning agent into the water tank unit and discharging the water stored in the water tank unit after a predetermined period of time, the user or manager must directly determine whether the cleaning operation by the cleaning agent has been completed, resulting in a problem that a difference in the degree of cleaning occurs. Furthermore, since this method involves injecting the cleaning agent into the water tank unit, there is also a problem that it is difficult to apply to a direct water purifier that is not equipped with the water tank unit. The second method is to separate a filter from a filtration unit for generating purified water, couple thereto a cleaning agent container in which the cleaning agent is stored, and then supply raw water to dissolve the cleaning agent and generate cleaning water. However, this method has a problem in that the filter inside the water purifier must be removed, so the water purifier must be partially disassembled to couple the cleaning agent container. In addition, since the cleaning water is produced using raw water after removing the filter, there is also a problem that foreign substances contained in the raw water remain in the cleaning water, causing another contamination during the cleaning process. Furthermore, even if a plurality of filters are provided in the filtration unit, and some filters are replaced with the cleaning agent container and the other filters are left behind to generate cleaning water, the supplied raw water cannot pass through the replaced filters, thereby reducing the cleanliness of the purified water. Since some foreign substances remain in the cleaning water produced using this purified water, still another contamination may occur during the cleaning process. In addition, the cleaning water flows in either a forward or reverse direction on the basis of the cleaning agent container, allowing only one-way cleaning, and the cleaning water moved to a water outlet unit is discharged through the water outlet unit or to a drain just before the water outlet, whereby the cleaning range is small.

Another conventional water purification device is disclosed in Korean Patent Laid-Open Publication No. 2020-0130972 filed by Coway Co., Ltd. This water purification device is equipped with a filtration unit including an electrodeionization filter to filter raw water, and a sterilization and cleaning unit including an organic acid filter. The sterilized and cleaned water generated through the organic acid filter flows into the electrodeionization filter to remove hard scale and biofilm. However, when removing the scale in this way, a separate space is required to place the organic acid filter inside the water purification device, thereby making it difficult to efficiently use the space inside the water purification device and to design the layout inside the water purification device. In addition, when the organic acid filter reaches the end of its life and needs to be replaced, it is necessary to disassemble the water purification device and replace the organic acid filter because the filter is located inside the water purification device. This makes it difficult for the user to directly replace the organic acid filter.

Korean Patent Laid-Open Publication No. 2013-0099563 filed by Coway Co., Ltd. discloses still another conventional water purification device, which is equipped with a filtration unit that combines a filter for filtering incoming raw water to produce purified water and a descaling kit for generating a descaling solution with the incoming raw water. However, even in the case of this water purification device, since the descaling kit is coupled to the filtration unit, a separate space is required to place the descaling filter inside the water purification device, thereby reducing the efficiency of the space inside the water purification device and making it difficult to design the layout inside the water purification device. Additionally, since the descaling kit is located inside the water purification device, it is difficult for the user to directly install and remove the descaling kit.

### PRIOR ART LITERATURE

### Patent Documents

(Patent Document 1) Korean Patent Laid-Open Publication No. 2011-0094172
(Patent Document 2) Korean Patent Laid-Open Publication No. 2020-0130972
(Patent Document 3) Korean Patent Laid-Open Publication No. 2013-0099563

### DISCLOSURE

### Technical Problem

In order to solve the above problems, an object of one aspect of the present invention is to provide a water purifier which is equipped with a separate descaling kit unit for removing scale, and a water outlet unit through which purified water and hot water are discharged is detachably coupled to a body casing; wherein washing water can be generated by separating the water outlet unit and then installing the descaling kit unit, thereby improving an efficiency of the space inside the water purifier and making it easier to design the layout inside the water purifier; wherein the washing water is produced using the purified water generated after passing through a filtration unit, thereby improving the cleanliness of the washing water and thus preventing another contamination from occurring during the scale removal process; and wherein the descaling kit unit can be easily replaced in a manner in which the user directly separates the water outlet unit from the body casing and then mounts the descaling kit unit, thereby improving user convenience.

Another object of an embodiment of the present invention is to provide a water purifier wherein the washing water generated in the descaling kit unit flows to a purified water flow path through a washing water supply flow path unit, and thus the flow of the washing water can be controlled to remove scale from a hot water flow path, a cold water flow path, and the purified water flow path, thereby improving the cleanliness of the water purifier; and wherein the washing water flows in the same direction as the flow direction of hot, cold, and purified water to remove scale, thereby improving an operational stability of the water purifier.

Still another object of an embodiment of the present invention is to provide a water purifier wherein the washing water flowing through the washing water supply flow path unit flows to a hot water generating unit through a first purified water flow path member, and therefore, the washing water flows smoothly without flowing back to the filtration unit, thereby improving an operational stability during the scale removal process.

Yet another object of an embodiment of the present invention is to provide a water purifier wherein the washing water flows into a first purified water inlet port of the hot water generating unit, removes scale inside the hot water generating unit, and then flows out through a hot water outlet port, thereby making it possible to effectively remove scale from the hot water generating unit, and improving an operational stability during the scale removal process through the smooth flow of the washing water.

Still another object of an embodiment of the present invention is to provide a water purifier wherein the washing water sequentially passes through the hot water generating unit and the hot water outlet flow path unit, and thus the flow directions of the washing water and the hot water are the same, thereby making it easy to control the flow of the washing water, and improving the cleanliness of the water purifier through effective removal of scale from the hot water generating unit and the hot water outlet flow path unit.

Still another object of an embodiment of the present invention is to provide a water purifier wherein the washing water flowing through the hot water outlet flow path unit is discharged to a scale storage space of the descaling kit unit, and thus scale can be discharged even in a situation where discharge to the outside is impossible, thereby ensuring the operational stability of the water purifier and improving user convenience.

An object of another embodiment of the present invention is to provide a water purifier wherein the washing water flowing through the washing water supply flow path unit flows to a cold water generating unit through a second purified water flow path member, and therefore, the washing water flows smoothly without flowing back to the filtration unit, thereby improving an operational stability during the scale removal process.

Another object of another embodiment of the present invention is to provide a water purifier wherein the washing water flows into a second purified water inlet port of the cold water generating unit, removes scale inside the cold water generating unit, and then flows out through a cold water outlet port, thereby making it possible to effectively remove scale from the cold water generating unit, and improving an operational stability during the scale removal process through the smooth flow of the washing water.

Still another object of another embodiment of the present invention is to provide a water purifier wherein the washing water sequentially passes through the cold water generating unit and the cold water outlet flow path unit, and thus the flow directions of the washing water and the cold water are the same, thereby making it easy to control the flow of the washing water, and improving the cleanliness of the water purifier through effective removal of scale from the cold water generating unit and the cold water outlet flow path unit.

Yet another object of another embodiment of the present invention is to provide a water purifier wherein the washing water flowing through the cold water outlet flow path unit is discharged to a scale storage space of the descaling kit unit, and thus scale can be discharged even in a situation where discharge to the outside is impossible, thereby ensuring the operational stability of the water purifier and improving user convenience.

An object of still another embodiment of the present invention is to provide a water purifier wherein the washing water flowing through the washing water supply flow path unit flows to a purified water outlet flow path unit through a third purified water flow path member, and therefore, the washing water flows smoothly without flowing back to the filtration unit, thereby improving an operational stability during the scale removal process.

Another object of still another embodiment of the present invention is to provide a water purifier wherein the washing water flowing through the purified water outlet flow path unit is discharged to a scale storage space of the descaling kit unit, and thus scale can be discharged even in a situation where discharge to the outside is impossible, thereby ensuring the operational stability of the water purifier and improving user convenience.

Yet another object of still another embodiment of the present invention is to provide a water purifier wherein the washing water, which passes through the washing water supply flow path unit to the purified flow path unit and is then recovered to the descaling kit unit, is circulated repeatedly to remove scale, thereby increasing the washing range.

In order to solve the above problems, an object of one aspect of the present invention is to provide a water purifier which equipped with a separate descaling kit unit for removing scale, and a water outlet unit through which purified water and hot water are discharged is detachably coupled to a body casing; wherein washing water can be generated by separating the water outlet unit and then installing the descaling kit unit, thereby improving an efficiency of the space inside the water purifier and making it easier to design the layout inside the water purifier; wherein the washing water is produced using the purified water generated after passing through a filtration unit, thereby improving the cleanliness of the washing water and thus preventing another contamination from occurring during the scale removal process; and wherein the descaling kit unit can be easily replaced in a manner in which the user directly separates the water outlet unit from the body casing and then mounts the descaling kit unit, thereby improving user convenience.

Another object of an embodiment of the present invention is to provide a water purifier wherein the washing water sequentially passes through the hot water outlet flow path unit and the hot water generating unit, thereby improving the cleanliness of the water purifier through effective removal of scale from the hot water outlet flow path unit and the hot water generating unit.

Yet another object of an embodiment of the present invention is to provide a water purifier wherein the washing water flows into a hot water inlet port of the hot water generating unit, removes scale inside the hot water generating unit, and then flows out through a first purified water inlet port, thereby making it possible to effectively remove scale from the hot water generating unit, and improving an operational stability during the scale removal process through the smooth flow of the washing water.

Still another object of an embodiment of the present invention is to provide a water purifier wherein the washing water flowing out through the first purified water inlet port flows to a first branch flow path through a first purified water flow path member, and therefore, the washing water is smoothly discharged without flowing back to the filtration unit, thereby improving an operational stability during the scale removal process.

Still another object of an embodiment of the present invention is to provide a water purifier wherein the washing water flowing through the first branch flow path is discharged to a scale storage space of the descaling kit unit through a first scale storage flow path, and thus scale can be discharged even in a situation where discharge to the outside is impossible, thereby ensuring the operational stability of the water purifier and improving user convenience.

Another object of another embodiment of the present invention is to provide a water purifier wherein the washing water flowing through the first branch flow path is discharged to the outside through a first scale discharge flow path, thereby ensuring the operational stability of the water purifier and improving user convenience.

Another object of an embodiment of the present invention is to provide a water purifier wherein the washing water passes through not only the hot water outlet flow path and the hot water generating unit, but also the purified water outlet flow path to remove scale from the purified water flow path as well, thereby improving the cleanliness of the water purifier.

Yet another object of an embodiment of the present invention is to provide a water purifier wherein the washing water, which sequentially passes through the hot water outlet flow path and the hot water generating unit and is then recovered to the descaling kit unit, is circulated repeatedly to remove scale, thereby increasing the washing range.

An object of another aspect of the present invention is to provide a water purifier equipped with a separate descaling kit unit for removing scale, and a water outlet unit through which purified water and cold water are discharged is detachably coupled to a body casing; wherein washing water can be generated by separating the water outlet unit and then installing the descaling kit unit, thereby improving an efficiency of the space inside the water purifier and making it easier to design the layout inside the water purifier; wherein the washing water is produced using the purified water generated after passing through a filtration unit, thereby improving the cleanliness of the washing water and thus preventing another contamination from occurring during the scale removal process; and wherein the descaling kit unit can be easily replaced in a manner in which the user directly separates the water outlet unit from the body casing and then mounts the descaling kit unit, thereby improving user convenience.

An object of still another embodiment of the present invention is to provide a water purifier wherein the washing water sequentially passes through the cold water outlet flow path unit and the cold water generating unit, thereby improving the cleanliness of the water purifier through effective removal of scale from the cold water outlet flow path unit and the cold water generating unit.

Another object of still another embodiment of the present invention is to provide a water purifier wherein the washing water flows into a cold water inlet port of the cold water generating unit, removes scale inside the cold water generating unit, and then flows out through a second purified water inlet port, thereby making it possible to effectively remove scale from the cold water generating unit, and improving an operational stability during the scale removal process through the smooth flow of the washing water.

Still another object of another embodiment of the present invention is to provide a water purifier wherein the washing water flowing out through the second purified water inlet port flows to a second branch flow path through a second purified water flow path member, and therefore, the washing water is smoothly discharged without flowing back to the filtration unit, thereby improving an operational stability during the scale removal process.

Still another object of another embodiment of the present invention is to provide a water purifier wherein the washing water flowing through the second branch flow path is discharged to a scale storage space of the descaling kit unit through a second scale storage flow path, and thus scale can be discharged even in a situation where discharge to the outside is impossible, thereby ensuring the operational stability of the water purifier and improving user convenience.

Still another object of another embodiment of the present invention is to provide a water purifier wherein the washing water flowing through the second branch flow path is discharged to the outside through a second scale discharge flow path, thereby ensuring the operational stability of the water purifier and improving user convenience.

Still another object of another embodiment of the present invention is to provide a water purifier wherein the washing water passes through not only the cold water outlet flow path and the cold water generating unit, but also the purified water outlet flow path to remove scale from the purified water flow path as well, thereby improving the cleanliness of the water purifier.

Yet another object of another embodiment of the present invention is to provide a water purifier wherein the washing water, which sequentially passes through the cold water outlet flow path and the cold water generating unit and is then recovered to the descaling kit unit, is circulated repeatedly to remove scale, thereby increasing the washing range.

### Technical Solution

In order to achieve the above object, a water purifier according to one aspect of the present invention includes: a body casing; a raw water flow path unit provided in the body casing and through which introduced raw water flows; a filtration unit for filtering the raw water to generate purified water; a purified water flow path unit through which the purified water flows; a purified water outlet flow path unit through which the purified water flows to be discharged to the outside; a water outlet unit detachably coupled to the body casing, connected to the purified water outlet flow path unit, and provided with a drinking water outlet to allow the purified water to be discharged to the outside; a descaling kit unit detachably coupled to the body casing so as to be replaceable with the water outlet unit and provided with an internal flow path to allow washing water to flow to the purified water flow path unit, wherein the washing water is generated by dissolving a descaling material in the purified water introduced through the purified water outlet flow path unit; and a control unit for controlling fluid flow in each of the units.

According to an embodiment of the present invention, the water purifier may further include a washing water supply flow path unit connecting the descaling kit unit and the purified water flow path unit so that the washing water flows to the purified water flow path unit.

According to an embodiment of the present invention, the water purifier may further include: a hot water generating unit for heating the purified water to generate hot water; and a hot water outlet flow path unit through which the hot water flows to be discharged to the outside, wherein the purified water flow path unit may comprise a first purified water flow path member connected to the hot water generating unit, and wherein the washing water supply flow path unit may be connected to the first purified water flow path member so that the washing water flows to the hot water generating unit.

In the water purifier according to an embodiment of the present invention, the hot water generating unit may include a first purified water inlet port connected to the first purified water flow path member, and a hot water outlet port connected to the hot water outlet flow path unit; and the control unit may control the washing water to flow into the first purified water inlet port and then flow out through the hot water outlet port.

In the water purifier according to an embodiment of the present invention, the control unit may control the flow of the washing water so that the washing water sequentially passes through the hot water generating unit and the hot water outlet flow path unit.

In the water purifier according to an embodiment of the present invention, the washing water flowing through the hot water outlet flow path unit may move to a scale storage space provided in the descaling kit unit.

According to another embodiment of the present invention, the water purifier may further include: a cold water generating unit for cooling the purified water to generate cold water; and a cold water outlet flow path unit through which the cold water flows to be discharged to the outside, wherein the purified water flow path unit may comprise a second purified water flow path member connected to the cold water generating unit, and wherein the washing water supply flow path unit may be connected to the second purified water flow path member so that the washing water flows to the cold water generating unit.

In the water purifier according to another embodiment of the present invention, the cold water generating unit may include a second purified water inlet port connected to the second purified water flow path member, and a cold water outlet port connected to the cold water outlet flow path unit; and the control unit may control the washing water to flow into the second purified water inlet port and then flow out through the cold water outlet port.

In the water purifier according to another embodiment of the present invention, the control unit may control the flow of the washing water so that the washing water sequentially passes through the cold water generating unit and the cold water outlet flow path unit.

In the water purifier according to another embodiment of the present invention, the washing water flowing through the cold water outlet flow path unit may move to a scale storage space provided in the descaling kit unit.

In the water purifier according to still another embodiment of the present invention, the purified water flow path unit may comprise a third purified water flow path member connected to the purified water outlet flow path unit; and the washing water supply flow path unit may be connected to the third purified water flow path member so that the washing water flows to the purified water outlet flow path unit.

In the water purifier according to yet another embodiment of the present invention, the washing water flowing through the purified water outlet flow path unit may move to a scale storage space provided in the descaling kit unit.

In the water purifier according to still another embodiment of the present invention, the control unit may control the flow of the washing water so that the washing water, which passes through the washing water supply flow path unit to the purified water flow path unit and is then recovered to the descaling kit unit, is circulated repeatedly to remove scale.

In order to achieve the above object, a water purifier according to another aspect of the present invention includes: a body casing; a raw water flow path unit provided in the body casing and through which introduced raw water flows; a filtration unit for filtering the raw water to generate purified water; a purified water flow path unit through which the purified water flows; a purified water outlet flow path unit through which the purified water flows to be discharged to the outside; a hot water generating unit for heating the purified water to generate hot water; a hot water outlet flow path unit through which the hot water flows to be discharged to the outside; a water outlet unit detachably coupled to the body casing, connected to each of the purified water outlet flow path unit and the hot water outlet flow path unit, and provided with a drinking water outlet to allow the purified water and hot water to be discharged to the outside; a descaling kit unit detachably coupled to the body casing so as to be replaceable with the water outlet unit and provided with an internal flow path to allow washing water to flow to the hot water outlet flow path unit, wherein the washing water is generated by dissolving a descaling material in the purified water introduced through the purified water outlet flow path unit; and a control unit for controlling fluid flow in each of the units.

In the water purifier according to an embodiment of the present invention, the control unit may control the flow of the washing water so that the washing water sequentially passes through the hot water outlet flow path unit and the hot water generating unit.

In the water purifier according to an embodiment of the present invention, the hot water generating unit may include a first purified water inlet port connected to the purified water flow path unit, and a hot water outlet port connected to the hot water outlet flow path unit; and the control unit may control the washing water to flow into the hot water outlet port and then flow out through the first purified water inlet port.

In the water purifier according to an embodiment of the present invention, the purified water flow path unit includes a first purified water flow path member connected to the first purified water inlet port, and the first purified water flow path member is connected to a first branch flow path through which the washing water discharged to the first purified water inlet port flows.

In the water purifier according to an embodiment of the present invention, the first branch flow path is connected to a first scale storage flow path communicating with a scale storage space provided in the descaling kit unit.

In the water purifier according to another embodiment of the present invention, the first branch flow path is connected to a first scale discharge flow path communicating with the outside so that the washing water is discharged to the outside.

In the water purifier according to still another embodiment of the present invention, the control unit may control the flow of the washing water so that the washing water, which sequentially passes through the hot water outlet flow path unit and the hot water generating unit, is recovered to the descaling kit unit via the purified water outlet flow path unit.

In the water purifier according to an embodiment of the present invention, the control unit may control the flow of the washing water so that the washing water, which passes sequentially through the hot water outlet flow path unit and the hot water generating unit and is then recovered to the descaling kit unit, is circulated repeatedly to remove scale.

A water purifier according to another aspect of the present invention includes: a body casing; a raw water flow path unit provided in the body casing and through which introduced raw water flows; a filtration unit for filtering the raw water to generate purified water; a purified water flow path unit through which the purified water flows; a purified water outlet flow path unit through which the purified water flows to be discharged to the outside; a cold water generating unit for cooling the purified water to generate cold water; a cold water outlet flow path unit through which the cold water flows to be discharged to the outside; a water outlet unit detachably coupled to the body casing, connected to each of the purified water outlet flow path unit and the cold water outlet flow path unit, and provided with a drinking water outlet to allow the purified water and cold water to be discharged to the outside; a descaling kit unit detachably coupled to the body casing so as to be replaceable with the water outlet unit and provided with an internal flow path to allow washing water to flow to the cold water outlet flow path unit, wherein the washing water is generated by dissolving a descaling material in the purified water introduced through the purified water outlet flow path unit; and a control unit for controlling fluid flow in each of the units.

In the water purifier according to still another embodiment of the present invention, the control unit may control the flow of the washing water so that the washing water sequentially passes through the cold water outlet flow path unit and the cold water generating unit.

In the water purifier according to still another embodiment of the present invention, the cold water generating unit may include a second purified water inlet port connected to the purified water flow path unit, and a cold water outlet port connected to the cold water outlet flow path unit; and the control unit may control the washing water to flow into the cold water outlet port and then flow out through the second purified water inlet port.

In the water purifier according to still another embodiment of the present invention, the purified water flow path unit includes a second purified water flow path member connected to the second purified water inlet port, and the second purified water flow path member is connected to a second branch flow path through which the washing water discharged to the second purified water inlet port flows.

In the water purifier according to still another embodiment of the present invention, the second branch flow path is connected to a second scale storage flow path communicating with a scale storage space provided in the descaling kit unit.

In the water purifier according to still another embodiment of the present invention, the second branch flow path is connected to a second scale discharge flow path communicating with the outside so that the washing water is discharged to the outside.

In the water purifier according to still another embodiment of the present invention, the control unit may control the flow of the washing water so that the washing water, which sequentially passes through the cold water outlet flow path unit and the cold water generating unit, is recovered to the descaling kit unit via the purified water outlet flow path unit.

In the water purifier according to still another embodiment of the present invention, the control unit may control the flow of the washing water so that the washing water, which passes sequentially through the cold water outlet flow path unit and the cold water generating unit and is then recovered to the descaling kit unit, is circulated repeatedly to remove scale.

### Advantageous Effects

With the above-described configuration, according to one aspect of the present invention, provided is a water purifier which is equipped with a separate descaling kit unit for removing scale, and a water outlet unit through which purified water and hot water are discharged is detachably coupled to a body casing; wherein washing water can be generated by separating the water outlet unit and then installing the descaling kit unit, thereby improving an efficiency of the space inside the water purifier and making it easier to design the layout inside the water purifier; wherein the washing water is produced using the purified water generated after passing through a filtration unit, thereby improving the cleanliness of the washing water and thus preventing another contamination from occurring during the scale removal process; and wherein the descaling kit unit can be easily replaced in a manner in which the user directly separates the water outlet unit from the body casing and then mounts the descaling kit unit, thereby improving user convenience.

According to an embodiment of the present invention, provided is a water purifier in which the washing water generated in the descaling kit unit flows to a purified water flow path unit through a washing water supply flow path unit, and thus the flow of the washing water can be controlled to remove scale from a hot water flow path, a cold water flow path, and the purified water flow path, thereby improving the cleanliness of the water purifier; and wherein the washing water flows in the same direction as the flow direction of hot, cold, and purified water to remove scale, thereby improving an operational stability of the water purifier.

Still according to an embodiment of the present invention, provided is a water purifier in which the washing water flowing through the washing water supply flow path unit flows to a hot water generating unit through a first purified water flow path member, and therefore, the washing water flows smoothly without flowing back to the filtration unit, thereby improving an operational stability during the scale removal process.

Yet according to an embodiment of the present invention, provided is a water purifier in which the washing water flows into a first purified water inlet port of the hot water generating unit, removes scale inside the hot water generating unit, and then flows out through a hot water outlet port, thereby making it possible to effectively remove scale from the hot water generating unit, and improving an operational stability during the scale removal process through the smooth flow of the washing water.

Still according to an embodiment of the present invention, provided is a water purifier in which the washing water sequentially passes through the hot water generating unit and the hot water outlet flow path unit, and thus the flow directions of the washing water and the hot water are the same, thereby making it easy to control the flow of the washing water, and improving the cleanliness of the water purifier through effective removal of scale from the hot water generating unit and the hot water outlet flow path unit.

Still according to an embodiment of the present invention, provided is a water purifier in which the washing water flowing through the hot water outlet flow path unit is discharged to a scale storage space of the descaling kit unit, and thus scale can be discharged even in a situation where discharge to the outside is impossible, thereby ensuring the operational stability of the water purifier and improving user convenience. According to another embodiment of the present invention, provided is a water purifier in which the washing water flowing through the washing water supply flow path unit flows to a cold water generating unit through a second purified water flow path member, and therefore, the washing water flows smoothly without flowing back to the filtration unit, thereby improving an operational stability during the scale removal process.

According to another embodiment of the present invention, provided is a water purifier in which the washing water flows into a second purified water inlet port of the cold water generating unit, removes scale inside the cold water generating unit, and then flows out through a cold water outlet port, thereby making it possible to effectively remove scale from the cold water generating unit, and improving an operational stability during the scale removal process through the smooth flow of the washing water.

Still according to another embodiment of the present invention, provided is a water purifier in which the washing water sequentially passes through the cold water generating unit and the cold water outlet flow path unit, and thus the flow directions of the washing water and the cold water are the same, thereby making it easy to control the flow of the washing water, and improving the cleanliness of the water purifier through effective removal of scale from the cold water generating unit and the cold water outlet flow path unit.

Yet according to another embodiment of the present invention, provided is a water purifier in which the washing water flowing through the cold water outlet flow path unit is discharged to a scale storage space of the descaling kit unit, and thus scale can be discharged even in a situation where discharge to the outside is impossible, thereby ensuring the operational stability of the water purifier and improving user convenience.

According to still another embodiment of the present invention, provided is a water purifier in which the washing water flowing through the washing water supply flow path unit flows to a purified water outlet flow path unit through a third purified water flow path member, and therefore, the washing water flows smoothly without flowing back to the filtration unit, thereby improving an operational stability during the scale removal process.

According to still another embodiment of the present invention, provided is a water purifier in which the washing water flowing through the purified water outlet flow path unit is discharged to a scale storage space of the descaling kit unit, and thus scale can be discharged even in a situation where discharge to the outside is impossible, thereby ensuring the operational stability of the water purifier and improving user convenience.

Yet according to still another embodiment of the present invention, provided is a water purifier in which the washing water, which passes through the washing water supply flow path unit to the purified flow path unit and is then recovered to the descaling kit unit, is circulated repeatedly to remove scale, thereby increasing the washing range.

With the above-described configuration, according to one aspect of the present invention, provided is a water purifier which is equipped with a separate descaling kit unit for removing scale, and a water outlet unit through which purified water and hot water are discharged is detachably coupled to a body casing; wherein washing water can be generated by separating the water outlet unit and then installing the descaling kit unit, thereby improving an efficiency of the space inside the water purifier and making it easier to design the layout inside the water purifier; wherein the washing water is produced using the purified water generated after passing through a filtration unit, thereby improving the cleanliness of the washing water and thus preventing another contamination from occurring during the scale removal process; and wherein the descaling kit unit can be easily replaced in a manner in which the user directly separates the water outlet unit from the body casing and then mounts the descaling kit unit, thereby improving user convenience.

According to an embodiment of the present invention, provided is a water purifier in which the washing water sequentially passes through the hot water outlet flow path unit and the hot water generating unit, thereby improving the cleanliness of the water purifier through effective removal of scale from the hot water outlet flow path unit and the hot water generating unit.

Yet according to an embodiment of the present invention, provided is a water purifier in which the washing water flows into a hot water inlet port of the hot water generating unit, removes scale inside the hot water generating unit, and then flows out through a first purified water inlet port, thereby making it possible to effectively remove scale from the hot water generating unit, and improving an operational stability during the scale removal process through the smooth flow of the washing water.

Still according to an embodiment of the present invention, provided is a water purifier in which the washing water flowing out through the first purified water inlet port flows to a first branch flow path through a first purified water flow path member, and therefore, the washing water is smoothly discharged without flowing back to the filtration unit, thereby improving an operational stability during the scale removal process.

Still according to an embodiment of the present invention, provided is a water purifier in which the washing water flowing through the first branch flow path is discharged to a scale storage space of the descaling kit unit through a first scale storage flow path, and thus scale can be discharged even in a situation where discharge to the outside is impossible, thereby ensuring the operational stability of the water purifier and improving user convenience.

According to another embodiment of the present invention, provided is a water purifier in which the washing water flowing through the first branch flow path is discharged to the outside through a first scale discharge flow path, thereby ensuring the operational stability of the water purifier and improving user convenience.

According to still another embodiment of the present invention, provided is a water purifier in which the washing water passes through not only the hot water outlet flow path unit and the hot water generating unit, but also the purified water outlet flow path unit to remove scale from the purified water flow path as well, thereby improving the cleanliness of the water purifier.

According to an embodiment of the present invention, provided is a water purifier in which the washing water, which sequentially passes through the hot water outlet flow path and the hot water generating unit and is then recovered to the descaling kit unit, is circulated repeatedly to remove scale, thereby increasing the washing range.

According to another aspect of the present invention, provided is a water purifier which is equipped with a separate descaling kit unit for removing scale, and a water outlet unit through which purified water and cold water are discharged is detachably coupled to a body casing; wherein washing water can be generated by separating the water outlet unit and then installing the descaling kit unit, thereby improving an efficiency of the space inside the water purifier and making it easier to design the layout inside the water purifier; wherein the washing water is produced using the purified water generated after passing through a filtration unit, thereby improving the cleanliness of the washing water and thus preventing another contamination from occurring during the scale removal process; and wherein the descaling kit unit can be easily replaced in a manner in which the user directly separates the water outlet unit from the body casing and then mounts the descaling kit unit, thereby improving user convenience.

According to still another embodiment of the present invention, provided is a water purifier in which the washing water sequentially passes through the cold water outlet flow path unit and the cold water generating unit, thereby improving the cleanliness of the water purifier through effective removal of scale from the cold water outlet flow path unit and the cold water generating unit.

According to still another embodiment of the present invention, provided is a water purifier in which the washing water flows into a cold water inlet port of the cold water generating unit, removes scale inside the cold water generating unit, and then flows out through a second purified water inlet port, thereby making it possible to effectively remove scale from the cold water generating unit, and improving an operational stability during the scale removal process through the smooth flow of the washing water.

Still according to another embodiment of the present invention, provided is a water purifier in which the washing water flowing out through the second purified water inlet port flows to a second branch flow path through a second purified water flow path member, and therefore, the washing water is smoothly discharged without flowing back to the filtration unit, thereby improving an operational stability during the scale removal process.

Still according to another embodiment of the present invention, provided is a water purifier in which the washing water flowing through the second branch flow path is discharged to a scale storage space of the descaling kit unit through a second scale storage flow path, and thus scale can be discharged even in a situation where discharge to the outside is impossible, thereby ensuring the operational stability of the water purifier and improving user convenience.

Still according to another embodiment of the present invention, provided is a water purifier in which the washing water flowing through the second branch flow path is discharged to the outside through a second scale discharge flow path, thereby ensuring the operational stability of the water purifier and improving user convenience.

Still according to another embodiment of the present invention, provided is a water purifier in which the washing water passes through not only the cold water outlet flow path and the cold water generating unit, but also the purified water outlet flow path unit to remove scale from the purified water flow path as well, thereby improving the cleanliness of the water purifier.

Yet according to another embodiment of the present invention, provided is a water purifier in which the washing water, which sequentially passes through the cold water outlet flow path and the cold water generating unit and is then recovered to the descaling kit unit, is circulated repeatedly to remove scale, thereby increasing the washing range.

### DESCRIPTION OF DRAWINGS

FIG. 1 is a water piping diagram of a water purifier according to an embodiment of the present invention, showing a fluid flow for discharging hot water.

FIG. 2 is a water piping diagram of a water purifier according to an embodiment of the present invention, showing a flow of washing water sequentially passing through a hot water generating unit and a hot water outlet flow path unit and then being recovered to a descaling kit unit.

FIG. 3 is an exploded perspective view of a water purifier according to an embodiment of the present invention.

FIG. 4 is a cross-sectional view taken along line I-I in FIG. 3.

FIG. 5 is a plan view of an upper cover according to an embodiment of the present invention.

FIG. 6 is a perspective view of a descaling kit unit according to an embodiment of the present invention.

FIG. 7 is a water piping diagram of a water purifier according to another embodiment of the present invention, showing a fluid flow for discharging cold water.

FIG. 8 is a water piping diagram of a water purifier according to another embodiment of the present invention, showing a flow of washing water sequentially passing through a cold water generating unit and a cold water outlet flow path unit and then being recovered to a descaling kit unit.

FIG. 9 is a water piping diagram of a water purifier according to still another embodiment of the present invention, showing a fluid flow for discharging purified water.

FIG. 10 is a water piping diagram of a water purifier according to still another embodiment of the present invention, showing a flow of washing water passing through a purified water outlet flow path unit and then being recovered to a descaling kit unit.

FIG. 11 is a water piping diagram of a water purifier according to still another embodiment of the present invention, showing a flow of washing water circulating through a hot water flow path, cold water flow path, and purified water flow path in the process of passing through a purified water flow path unit and then being recovered to a descaling kit unit.

FIG. 12 is a water piping diagram of a water purifier according to an embodiment of the present invention, showing a fluid flow for discharging purified water.

FIG. 13 is a water piping diagram of a water purifier according to an embodiment of the present invention, showing a fluid flow for discharging hot water.

FIG. 14 is a water piping diagram of a water purifier according to an embodiment of the present invention, showing a flow of washing water sequentially passing through a hot water outlet flow path unit and a hot water generating unit and then being recovered to a descaling kit unit.

FIG. 15 is a water piping diagram of a water purifier according to another embodiment of the present invention, showing a flow of washing water sequentially passing through a hot water outlet flow path unit and a hot water generating unit and then being discharged to the outside.

FIG. 16 is a water piping diagram of a water purifier according to still another embodiment of the present invention, showing a flow of washing water sequentially passing through a hot water outlet flow path unit, a hot water generating unit and a purified water outlet flow path unit and then being recovered to a descaling kit unit.

FIG. 17 is an exploded perspective view of a water purifier according to an embodiment of the present invention.

FIG. 18 is a cross-sectional view taken along line I-I in FIG. 17.

FIG. 19 is a plan view of an upper cover according to an embodiment of the present invention.

FIG. 20 is a perspective view of a descaling kit unit according to an embodiment of the present invention.

FIG. 21 is a water piping diagram of a water purifier according to still another embodiment of the present invention, showing a fluid flow for discharging cold water.

FIG. 22 is a water piping diagram of a water purifier according to still another embodiment of the present invention, showing a flow of washing water sequentially passing through a cold water outlet flow path unit and a cold water generating unit and then being recovered to a descaling kit unit.

FIG. 23 is a water piping diagram of a water purifier according to still another embodiment of the present invention, showing a flow of washing water sequentially passing through a cold water outlet flow path unit and a cold water generating unit and then being discharged to the outside.

FIG. 24 is a water piping diagram of a water purifier according to still another embodiment of the present invention, showing a flow of washing water sequentially passing through a cold water outlet flow path unit, a cold water generating unit and a purified water outlet flow path unit and then being recovered to a descaling kit unit.

### BEST MODES OF THE INVENTION

The words and terms used in the specification and claims of the present application are not to be construed as being limited to their ordinary or dictionary meanings, but should be interpreted as meanings and concepts consistent with the technical spirit of the present invention, based on the principle that the inventor may define terms and concepts to best describe his invention.

Therefore, the configurations shown in the embodiments described in the specification and the drawings correspond to preferred embodiments of the present invention, and do not represent the entire technical ideas of the present invention, so the configurations may have various equivalents and variations to replace them at the time of filing the present invention.

In the specification, terms such as “comprise” or “have” are intended to explain that a feature, number, step, operation, component, part or combination thereof described in the specification is present, but should not be construed to preclude the possibility of the presence or addition of one or more other features, numbers, steps, operations, components, parts or combinations thereof.

When a component is said to be “before”, “after”, “above” or “below” another component, it includes a case in which the component is placed “before”, “after”, “above” or “below” another component so as to be in direct contact with each other, as well as a case where any additional component is disposed between the two components, unless there are special circumstances. In addition, when a component is said to be “connected” to another component, it includes cases where they are not only directly connected to each other but also indirectly connected to each other, unless there are special circumstances.

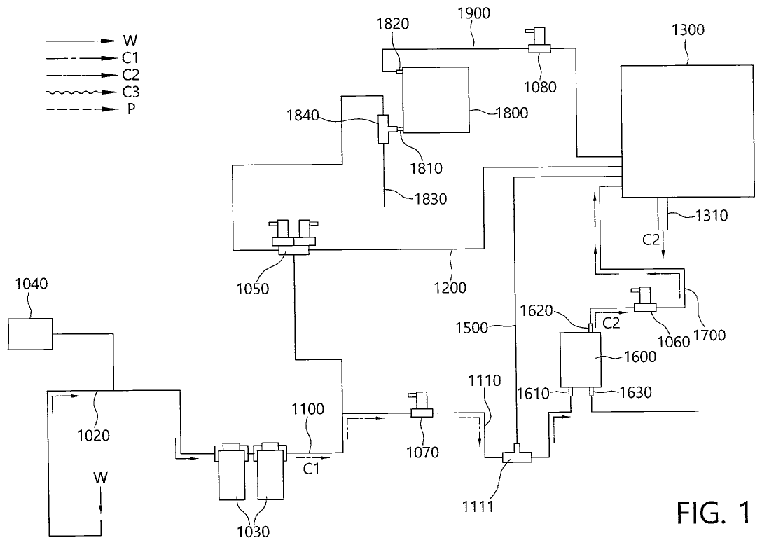

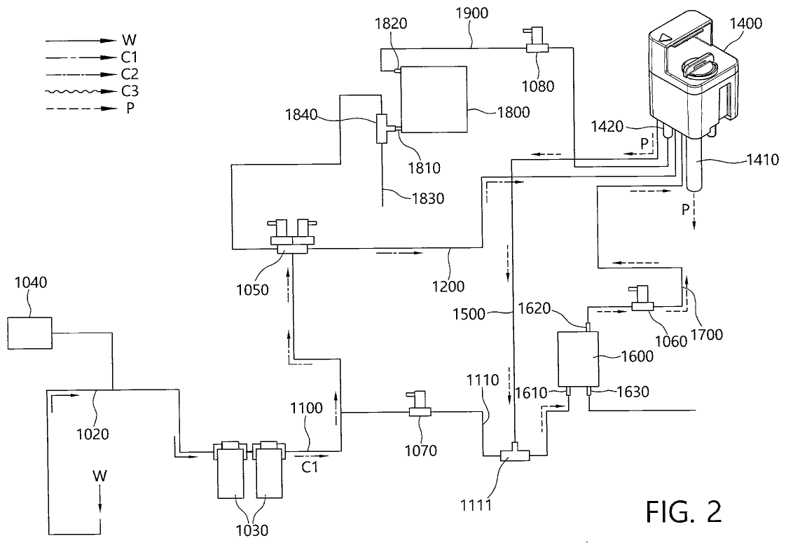

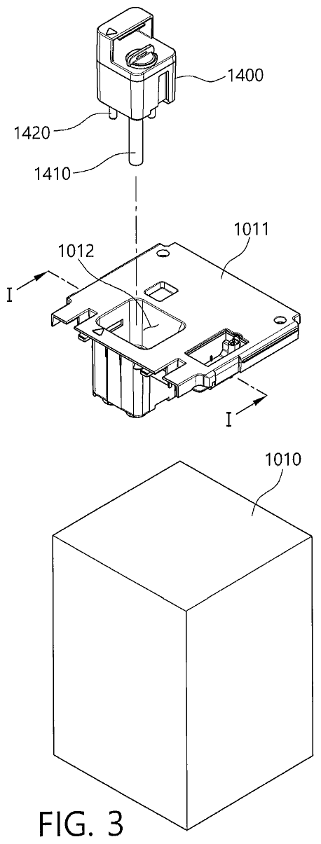

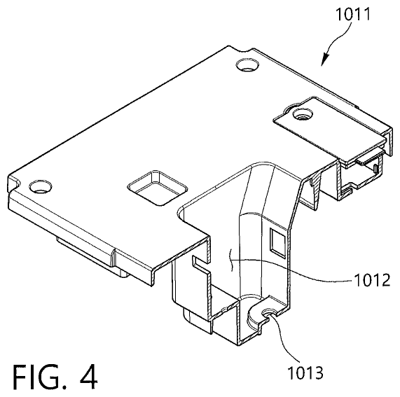

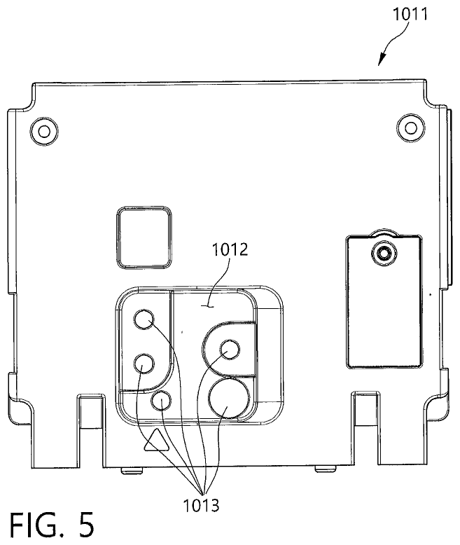

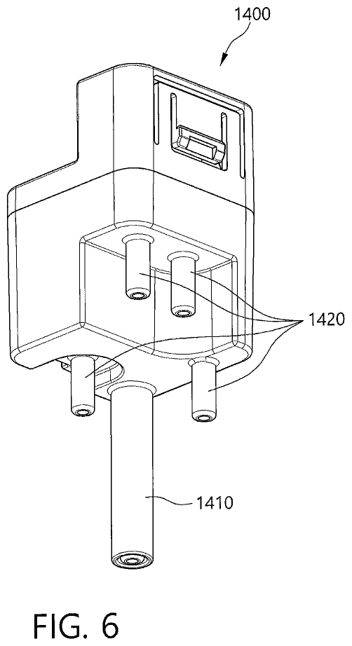

Hereinafter, a water purifier according to the present invention will be described with reference to the drawings. FIG. 1 is a water piping diagram of a water purifier according to an embodiment of the present invention, showing a fluid flow for discharging hot water; FIG. 2 is a water piping diagram of a water purifier according to an embodiment of the present invention, showing a flow of washing water sequentially passing through a hot water generating unit and a hot water outlet flow path unit and then being recovered to a descaling kit unit; FIG. 3 is an exploded perspective view of a water purifier according to an embodiment of the present invention; FIG. 4 is a cross-sectional view taken along line I-I in FIG. 3; FIG. 5 is a plan view of an upper cover according to an embodiment of the present invention; and FIG. 6 is a perspective view of a descaling kit unit according to an embodiment of the present invention. In order to clearly describe the present invention, parts irrelevant to the description are omitted from the drawings.

As shown in FIG. 1, a water purifier according to an embodiment of the present invention includes: a body casing 1010; a raw water flow path unit 1020 provided in the body casing 1010 and through which introduced raw water (W) flows; a filtration unit 1030 for filtering the raw water (W) to generate purified water (C1); a purified water flow path unit 1100 through which the purified water (C1) flows; a purified water outlet flow path unit 1200 through which the purified water (C1) flows to be discharged to the outside; a water outlet unit 1300 detachably coupled to the body casing 1010, connected to the purified water outlet flow path unit 1200, and provided with a drinking water outlet 1310 to allow the purified water (C1) to be discharged to the outside.

The raw water flow path unit 1020 may be provided with a damping valve for allowing the incoming raw water (W) to flow and reducing the pressure of the incoming raw water (W). Additionally, it may be equipped with a high pressure solenoid valve (NOS valve) for regulating the flow of the raw water (W). The filtration unit 1030 filters the raw water (W) to generate purified water (C1), and may include several filters for this purpose. For example, the filtration unit 1030 may include a pre-carbon filter, a membrane filter, and a post-carbon filter. In addition, the filtration unit 1030 may include an electric deionization type filter. The electric deionization refers to electro deionization (EDI), continuous electro deionization (CEDI), capacitive deionization (CDI), etc. As shown in FIG. 1, the purified water (C1) generated in this way may sequentially pass through the purified water flow path unit 1100 and the purified water outlet flow path unit 1200 and then be provided to a user through the water outlet unit 1300. In this case, the purified water flow path unit 1100 may be provided with a branch valve 1050, and the purified water (C1) moving through the purified water flow path unit 1100 moves to the purified water outlet flow path unit 1200, or a cold water generating unit 1800 which will be described later, through the branch valve 1050. Alternatively, as shown in FIG. 1, the purified water (C1) may sequentially pass through the hot water generating unit 1600 and the hot water outlet flow unit 1700 and then be provided to a user through the water outlet unit 1300. In this case, the hot water outlet flow path unit 1700 may be provided with a hot water valve 1060 for regulating the flow of the hot water (C2). The water outlet unit 1300 may be provided with a drinking water outlet 1310 to allow the purified water (C1) and the hot water (C2) to be discharged. In this case, the purified water outlet flow path unit 1200 and the hot water outlet flow path unit 1700 are not limited to separate tubing or piping, and may be fittings connected to the water outlet unit 1300. In other words, if the tubing or piping through which the purified water (C1) or hot water (C2) flows is collected and modularized inside the water outlet unit 1300, it can be simply installed by connecting the water outlet unit 1300 to the fittings, and if necessary, can also be easily replaced by separating the water outlet unit 1300 from the fittings and replacing it. In this case, the drinking water outlet 1310 provided in the water outlet unit 1300 may be a water outlet faucet for providing the purified water (C1) or hot water (C2) to the user. Alternatively, the drinking water outlet 1310 provided in the water outlet unit 1300 may be a tubing or piping connected to a water outlet faucet provided separately from the water outlet unit 1300. That is, the water outlet unit 1300 may be equipped with only the tubing or piping through which the purified water (C1) or hot water (C2) flows, and the purified water (C1) or hot water (C2) flowing through such tubing or piping may also be provided to the user through a separate water outlet faucet.

As shown in FIG. 2, the water purifier may include: a descaling kit unit 1400 detachably coupled to the body casing 1010 so as to be replaceable with the water outlet unit 1300 and provided with an internal flow path to allow washing water (P) to flow to the purified water flow path unit 1100, wherein the washing water (P) is generated by dissolving a descaling material in the purified water (C1) introduced through the purified water outlet flow path unit 1200; and a control unit 1040 for controlling fluid flow in each of the units.

As shown in FIGS. 3 to 6, the body casing 1010 provides an internal space in which various parts constituting the water purifier are accommodated, and may be formed in a hexahedral shape, but is not necessarily limited to this shape as long as an internal space capable of accommodating the above-mentioned parts is formed. The body casing 1010 may be provided with an upper cover 1011 for opening and closing the internal space, wherein the upper cover 1011 is configured to be provided with a seating groove 1012 to which the water outlet unit 1300 is detachably coupled, so that the purified water (C1) or hot water (C2) is discharged to the outside through the water outlet unit 1300. The descaling kit unit 1400 may also be detachably coupled to the seating groove 1012 provided in the upper cover 1011 of the body casing 1010, and may be provided with an internal flow path to allow washing water (P) to flow to the purified water flow path unit 1100, wherein the washing water (P) is generated by dissolving a descaling material in the purified water introduced through the purified water outlet flow path unit 1200. The descaling kit unit 1400 may be provided with a scale storage space that accommodates the washing water (P) recovered after scale removal, and the washing water (P) accommodated in this scale storage space may be discharged to the outside through the washing water outlet 1410. In addition, the descaling kit unit 1400 may be provided with an accommodation space in which the purified water (C1) is accommodated, wherein the accommodation space communicates with each of the flow paths through which the purified water (C1), hot water (C2), and cold water (C3) flow, and a washing water port 1420 may be provided so that each of these flow paths communicates with the accommodation space. The accommodation space may be a scale storage space in which the recovered washing water (P) is accommodated. The seating groove 1012 provided in the upper cover 1011 of the body casing 1010 may be provided with a port hole 1013 through which the washing water port 1420 passes and is coupled. The control unit 1040 can control the flow of the washing water (P) as well as the flows of the purified water (C1) and hot water (C2) flowing through each flow path.

That is, the water purifier is equipped with a separate descaling kit unit 1400 for removing scale, and a water outlet unit 1300 through which the purified water (C1) and hot water (C2) are discharged is detachably coupled to the body casing 1010; whereby the washing water (P) can be generated by separating the water outlet unit 1300 and then installing the descaling kit unit 1400, thereby improving an efficiency of the space inside the water purifier and making it easier to design the layout inside the water purifier; whereby the washing water (P) is produced using the purified water (C1) generated after passing through the filtration unit 1030, thereby improving the cleanliness of the washing water (P) and thus preventing another contamination from occurring during the scale removal process; and whereby the descaling kit unit 1400 can be easily replaced in a manner in which the user directly separates the water outlet unit 1300 from the body casing 1010 and then mounts the descaling kit unit 1400, thereby improving user convenience.

As shown in FIG. 2, the water purifier according to an embodiment of the present invention may include a washing water supply flow path unit 1500 connecting the descaling kit unit 1400 and the purified water flow path unit 1100 so that the washing water (P) flows to the purified water flow path unit 1100. That is, the washing water (P) generated in the descaling kit unit 1400 flows to the purified water flow path unit 1100 through the washing water supply flow path unit 1500, and thus the flow of the washing water (P) can be controlled to remove scale from the hot water (C2) flow path, the cold water (C3) flow path, and the purified water (C1) flow path, thereby improving the cleanliness of the water purifier; and the washing water (P) flows in the same direction as the flow direction of hot water (C2), cold water (C3), and purified water (C1) to remove scale, thereby improving an operational stability of the water purifier.

As shown in FIG. 2, the water purifier according to an embodiment of the present invention may include a hot water generating unit 1600 for heating the purified water (C1) to generate the hot water (C2), and a hot water outlet flow path unit 1700 through which the hot water (C2) flows so that the hot water (C2) is discharged to the outside, wherein the purified water flow path unit 1100 includes a first purified water flow path member 1110 connected to the hot water generating unit 1600, and the washing water supply flow path unit 1500 may be connected to the first purified water flow path member 1110 so that the washing water (P) flows to the hot water generating unit 1600. In this case, the first purified water flow path member 1110 may be provided with a first branch flow path 1111 so that the washing water (P) flows to the hot water generating unit 1600. Additionally, the first purified water flow path member 1110 may be provided with a flow control valve 1070 for controlling the flow rate of the purified water (C1) moving to the hot water generating unit 1600. That is, since the washing water (P) flowing through the washing water supply flow path unit 1500 flows to the hot water generating unit 1600 through the first purified water flow path member 1110, the washing water (P) flows smoothly without flowing back to the filtration unit 1030, thereby improving an operational stability during the scale removal process.

As shown in FIG. 2, in the water purifier according to an embodiment of the present invention, the hot water generating unit 1600 may include a first purified water inlet port 1610 connected to the first purified water flow path member 1110, and a hot water outlet port 1620 connected to the hot water outlet flow path unit 1700; and the control unit 1040 may control the washing water (P) to flow into the first purified water inlet port 1610 and then flow out through the hot water outlet port 1620. This hot water generating unit 1600 may be provided with a hot water housing in which the purified water (C1) is accommodated, and the purified water moves into the hot water housing through the first purified water inlet port 1610 connected to the first purified water flow path member 1110. The hot water (C2) heated inside the hot water housing moves out of the hot water housing through the hot water outlet port 1620 connected to the hot water outlet flow path unit 1700. The hot water generating unit 1600 may be equipped with a heater for heating the purified water (C1) stored inside the hot water housing, and a water level detection sensor for detecting the water level of the purified water (C1) stored inside the hot water housing. For example, the heater may be a plate type heater, but is not necessarily limited thereto, and any configuration may be used as long as it can heat the purified water (C1) stored in the hot water housing. In the plate type heater, the packaging efficiency can be improved by being formed to extend along the side wall of the hot water housing, and the heating capacity can be changed by adjusting the power supplied to the plate type heater. In addition, the hot water generating unit 1600 may be provided with a separate hot water drain port 1330, and can be configured to discharge the washing water (P) to the outside through the hot water drain port 1330. In this case, when the washing water (P) is heated using the hot water generating unit 1600, the performance of removing scale from the hot water (C2) flow path is improved.

That is, the washing water (P) generated by dissolving a descaling material in the purified water (C1) introduced into the descaling kit unit 1400 flows into the first purified water inlet port 1610 of the hot water generating unit 1600 to remove scale inside the hot water generating unit 1600, and then flows out through the hot water outlet port 1620 (in the same direction as the hot water flow direction), whereby it is possible to effectively remove scale from the hot water generating unit 1600, and an operational stability during the scale removal process is improved through the smooth flow of the washing water (P).

As shown in FIG. 2, in the water purifier according to an embodiment of the present invention, the control unit 1040 may control the flow of the washing water (P) so that the washing water (P) sequentially passes through the hot water generating unit 1600 and the hot water outlet flow path unit 1700. That is, the washing water (P) sequentially passes through the hot water generating unit 1600 and the hot water outlet flow path unit 1700, and thus the flow directions of the washing water (P) and the hot water (C2) are the same, thereby making it easy to control the flow of the washing water (P), and improving the cleanliness of the water purifier through effective removal of scale from the hot water generating unit 1600 and the hot water outlet flow path unit 1700. In this case, when the hot water valve 1060 is opened so that the washing water (P) moves to the hot water generating unit 1600 and the hot water outlet flow path unit 1700, the pressure of the raw water (W) can be transmitted to the washing water (P) through the purified water (C1), allowing the washing water (P) to flow smoothly.

As shown in FIG. 2, in the water purifier according to an embodiment of the present invention, the washing water (P) flowing through the hot water outlet flow path unit 1700 can move to the scale storage space provided in the descaling kit unit 1400. In this case, as described above, if the drinking water outlet 1310 provided in the water outlet unit 1300 is a water outlet faucet for providing the purified water (C1) or hot water (C2) to the user, the descaling kit unit 1400, which is replaced with the water outlet unit 1300, may also be provided with a washing water outlet 1410 for discharging the washing water (P) as well as the tubing or piping. The washing water (P) accommodated in the scale storage space may also be discharged to the outside through the washing water outlet 1410. That is, the washing water (P) flowing through the hot water outlet flow path unit 1700 is discharged to the scale storage space of the descaling kit unit 1400, and thus scale can be discharged even in a situation where discharge to the outside is impossible, thereby ensuring the operational stability of the water purifier and improving user convenience. Alternatively, as the water outlet faucet is provided separately from the water outlet unit 1300, if the water outlet unit 1300 is provided with only tubing or piping, the descaling kit unit 1400, which is replaced with the water outlet unit 1300, may also be provided with only tubing or piping. In this case, the washing water (P) may be discharged to the outside through a separate drain line.

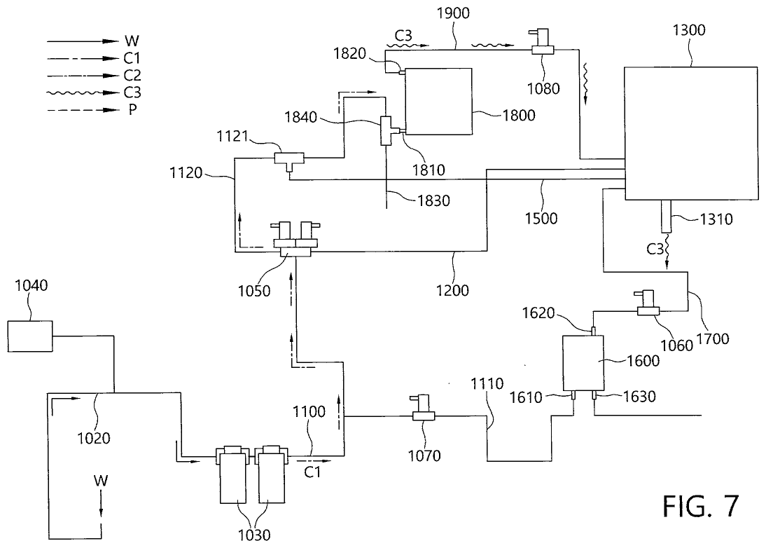

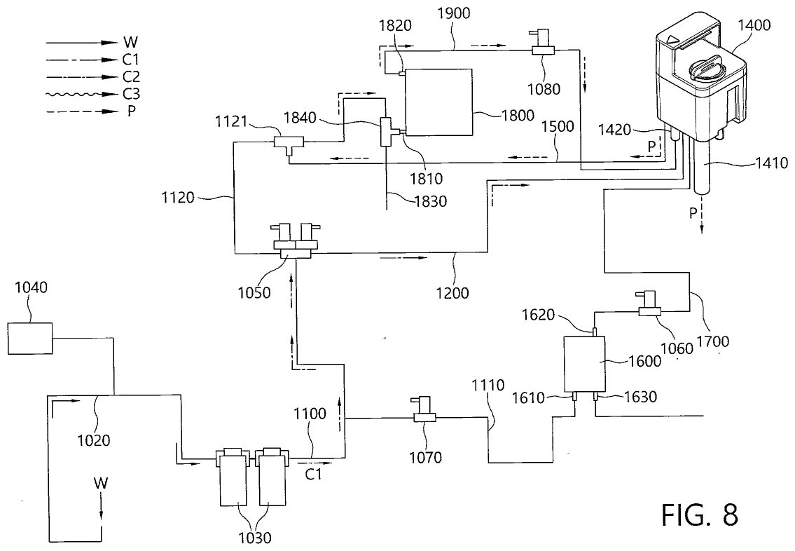

FIG. 7 is a water piping diagram of a water purifier according to another embodiment of the present invention, showing a fluid flow for discharging cold water, and FIG. 8 is a water piping diagram of a water purifier according to another embodiment of the present invention, showing a flow of washing water sequentially passing through a cold water generating unit and a cold water outlet flow path unit and then being recovered to a descaling kit unit.

As shown in FIGS. 7 and 8, the water purifier according to an embodiment of the present invention may include a cold water generating unit 1800 for cooling the purified water (C1) to generate the cold water (C3), and a cold water outlet flow path unit 1900 through which the cold water (C3) flows so that the cold water (C3) is discharged to the outside, wherein the purified water flow path unit 1100 includes a second purified water flow path member 1120 connected to the cold water generating unit 1800, and the washing water supply flow path unit 1500 may be connected to the second purified water flow path member 1120 so that the washing water (P) flows to the cold water generating unit 1800. That is, the purified water (C1) supplied through the purified water flow path unit 1100 is cooled through the cold water generating unit 1800, and the generated cold water (C3) may move to the water outlet unit 1300 through the cold water outlet flow path unit 1900 and then be provided to the user. The cold water outlet flow path unit 1900 may be provided with a cold water valve 1080 for regulating the flow of the cold water (C3). The water outlet unit 1300 may be provided with a drinking water outlet 1310 to allow the purified water (C1) and the cold water (C3) to be discharged. In this case, the purified water outlet flow path unit 1200 and the cold water outlet flow path unit 1900 are not limited to separate tubing or piping, and may be fittings connected to the water outlet unit 1300. In other words, if the tubing or piping through which the purified water (C1) or cold water (C3) flows is collected and modularized inside the water outlet unit 1300, it can be simply installed by connecting the water outlet unit 1300 to the fittings, and if necessary, can also be easily replaced by separating the water outlet unit 1300 from the fittings and replacing it. In this case, the drinking water outlet 1310 provided in the water outlet unit 1300 may be a water outlet faucet for providing the purified water (C1) or cold water (C3) to the user. Alternatively, the drinking water outlet 1310 provided in the water outlet unit 1300 may be a tubing or piping connected to a water outlet faucet provided separately from the water outlet unit 1300. That is, the water outlet unit 1300 may be equipped with only the tubing or piping through which the purified water (C1) or cold water (C3) flows, and the purified water (C1) or cold water (C3) flowing through such tubing or piping may also be provided to the user through a separate water outlet faucet. In this case, the second purified water flow path member 1120 may be provided with a second branch flow path 1121 so that the washing water (P) flows to the cold water generating unit 1800. That is, since the washing water (P) flowing through the washing water supply flow path unit 1500 flows to the cold water generating unit 1800 through the second purified water flow path member 1120, the washing water (P) flows smoothly without flowing back to the filtration unit 1030, thereby improving an operational stability during the scale removal process.

As shown in FIG. 8, in the water purifier according to another embodiment of the present invention, the cold water generating unit 1800 may include a second purified water inlet port 1810 connected to the second purified water flow path member 1120, and a cold water outlet port 1820 connected to the cold water outlet flow path unit 1900; and the control unit 1040 may control the washing water (P) to flow into the second purified water inlet port 1810 and then flow out through the cold water outlet port 1820. This cold water generating unit 1800 may be provided with a cold water housing in which the purified water (C1) is accommodated, and the purified water moves into the cold water housing through the second purified water inlet port 1810 connected to the purified water flow path unit 1100. The cold water (C3) heated inside the cold water housing moves out of the cold water housing through the cold water outlet port 1820 connected to the cold water outlet flow path unit 1900. The cold water generating unit 1800 may be equipped with a cooling member for cooling the purified water (C1) stored inside the cold water housing, and a water level detection sensor for detecting the water level of the purified water (C1) stored inside the cold water housing. For example, the cooling member may be a cooling coil through which low-temperature refrigerant flows, or a thermoelectric module that cools the purified water (C1) using a thermoelectric element, but is not necessarily limited thereto, and any configuration may be used as long as it can cool the purified water (C1) stored in the cold water housing. In addition, the cold water generating unit 1800 may be provided with a separate cold water drain port 1830, and can be configured to discharge the washing water (P) to the outside through the cold water drain port 1830. The cold water generating unit 1800 may be provided with a cold water branch flow path 1840 connecting the purified water flow path unit 1100 and the cold water drain port 1830.

That is, the washing water (P) generated by dissolving a descaling material in the purified water (C1) introduced into the descaling kit unit 1400 flows into the second purified water inlet port 1810 of the cold water generating unit 1800 to remove scale inside the cold water generating unit 1800, and then flows out through the cold water outlet port 1820 (in the same direction as the cold water flow direction), whereby it is possible to effectively remove scale from the cold water generating unit 1800, and an operational stability during the scale removal process is improved through the smooth flow of the washing water (P).

As shown in FIG. 8, in the water purifier according to another embodiment of the present invention, the control unit 1040 may control the flow of the washing water (P) so that the washing water (P) sequentially passes through the cold water generating unit 1800 and the cold water outlet flow path unit 1900. That is, the washing water (P) sequentially passes through the cold water generating unit 1800 and the cold water outlet flow path unit 1900, and thus the flow directions of the washing water (P) and the cold water (C3) are the same, thereby making it easy to control the flow of the washing water (P), and improving the cleanliness of the water purifier through effective removal of scale from the cold water generating unit 1800 and the cold water outlet flow path unit 1900. In this case, when the cold water valve 1080 is opened so that the washing water (P) moves to the cold water generating unit 1800 and the cold water outlet flow path unit 1900, the pressure of the raw water (W) can be transmitted to the washing water (P) through the purified water (C1), allowing the washing water (P) to flow smoothly.

As shown in FIG. 8, in the water purifier according to another embodiment of the present invention, the washing water (P) flowing through the cold water outlet flow path unit 1900 can move to the scale storage space provided in the descaling kit unit 1400. In this case, as described above, if the drinking water outlet 1310 provided in the water outlet unit 1300 is a water outlet faucet for providing the purified water (C1) or cold water (C3) to the user, the descaling kit unit 1400, which is replaced with the water outlet unit 1300, may also be provided with a washing water outlet 1410 for discharging the washing water (P) as well as the tubing or piping. The washing water (P) accommodated in the scale storage space may also be discharged to the outside through the washing water outlet 1410. That is, the washing water (P) flowing through the cold water outlet flow path unit 1900 is discharged to the scale storage space of the descaling kit unit 1400, and thus scale can be discharged even in a situation where discharge to the outside is impossible, thereby ensuring the operational stability of the water purifier and improving user convenience. Alternatively, as the water outlet faucet is provided separately from the water outlet unit 1300, if the water outlet unit 1300 is provided with only tubing or piping, the descaling kit unit 1400, which is replaced with the water outlet unit 1300, may also be provided with only tubing or piping. In this case, the washing water (P) may be discharged to the outside through a separate drain line.

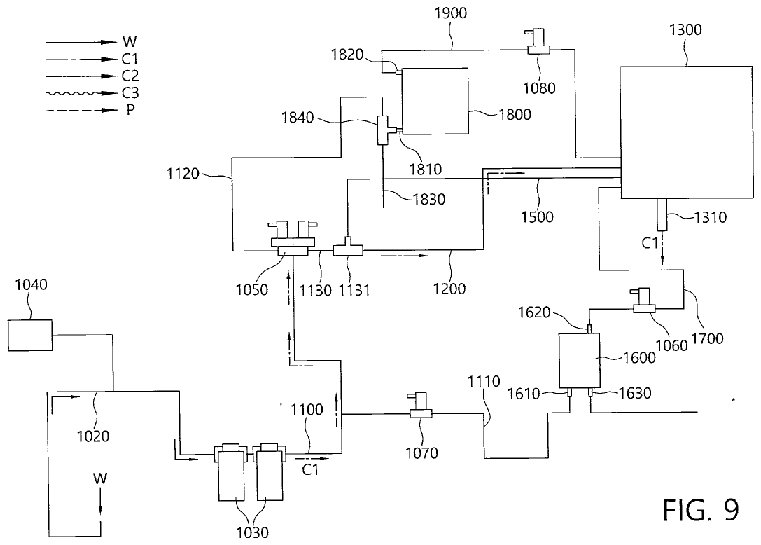

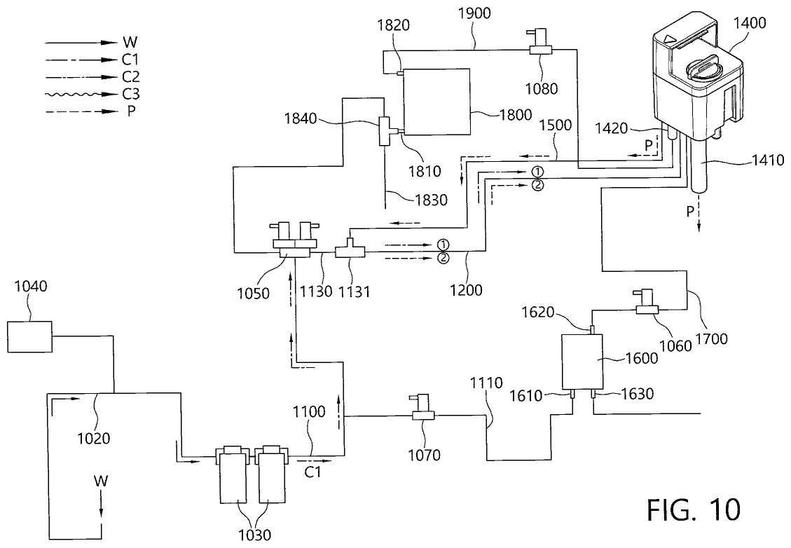

FIG. 9 is a water piping diagram of a water purifier according to still another embodiment of the present invention, showing a fluid flow for discharging purified water; and FIG. 10 is a water piping diagram of a water purifier according to still another embodiment of the present invention, showing a flow of washing water passing through a purified water outlet flow path unit and then being recovered to a descaling kit unit.

As shown in FIGS. 9 and 10, in the water purifier according to still another embodiment of the present invention, the purified water flow path unit 1100 includes a third purified water flow path member 1130 connected to the purified water outlet flow path unit 1200, and the washing water supply flow path unit 1500 may be connected to the third purified water flow path member 1130 so that the washing water (P) flows to the purified water outlet flow path unit 1200. That is, the purified water (C1) supplied through the purified water flow path unit 1100 may move to the water outlet unit 1300 through the purified water outlet flow path unit 1200 and then be provided to the user. The water outlet unit 1300 may be provided with a drinking water outlet 1310 to allow the purified water (C1) to be discharged. In this case, the third purified water flow path member 1130 may be provided with a third branch flow path 1131 so that the washing water (P) flows to the purified water outlet flow path unit 1200. That is, the purified water (C1) generated through the filtration unit 1030 passes sequentially through the purified water flow path unit 1100 and the purified water outlet flow path unit 1200 (\textcircled{1} flow) and moves to the descaling kit unit 1400. The washing water (P) generated by dissolving a descaling material in the purified water (C1) introduced into the descaling kit unit 1400 also flows through the purified water outlet flow path unit 1200 via the washing water supply flow path unit 1500 and the third branch flow path 1131 (\textcircled{2} flow) to removes the scale from the flow path through which the purified water (C1) flows. As described above, since the washing water (P) flowing through the washing water supply flow path unit 1500 flows to the purified water outlet flow path unit 1200 through the third purified water flow path member 1130, the washing water (P) flows smoothly without flowing back to the filtration unit 1030, thereby improving an operational stability during the scale removal process.

As shown in FIG. 10, in the water purifier according to still another embodiment of the present invention, the washing water (P) flowing through the purified water outlet flow path unit 1200 can move to the scale storage space provided in the descaling kit unit 1400. In this case, as described above, the washing water (P) accommodated in the scale storage space may also be discharged to the outside through the washing water outlet 1410. That is, the washing water (P) flowing through the purified water outlet flow path unit 1200 is discharged to the scale storage space of the descaling kit unit 1400, and thus scale can be discharged even in a situation where discharge to the outside is impossible, thereby ensuring the operational stability of the water purifier and improving user convenience.

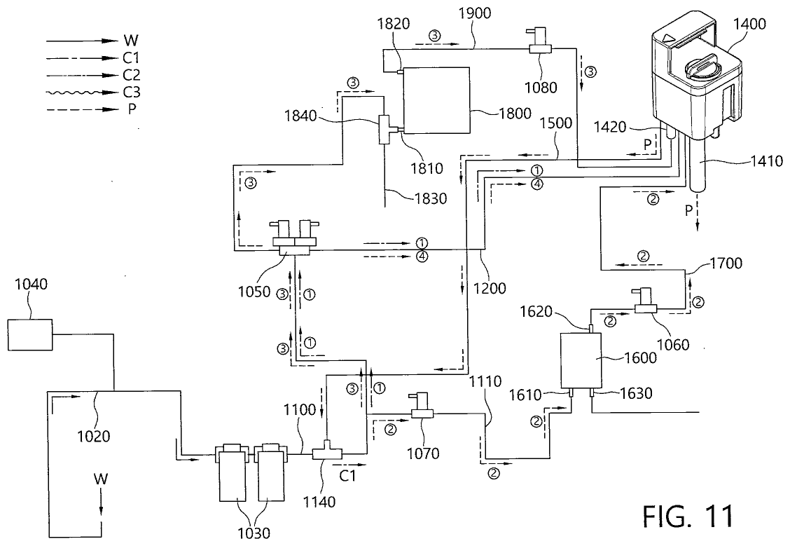

FIG. 11 is a water piping diagram of a water purifier according to still another embodiment of the present invention, showing a flow of washing water circulating through a hot water flow path, cold water flow path, and purified water flow path in the process of passing through a purified water flow path unit and then being recovered to a descaling kit unit.

As shown in FIG. 11, in the water purifier according to still another embodiment of the present invention, the control unit 1040 may control the flow of the washing water (P) so that the washing water (P), which passes through the purified water flow path unit 1100 via the washing water supply flow path unit 1500 and is then recovered to the descaling kit unit 1400, is circulated repeatedly to remove scale. In this case, the purified water flow path unit 1100 may be provided with a fourth branch flow path 1140 connected to the washing water supply flow path unit 1500, wherein the fourth branch flow path 1140 may be disposed at the rear end of the filtration unit 1030. That is, the purified water (C1) generated through the filtration unit 1030 passes sequentially through the purified water flow path unit 1100 and the purified water outlet flow path unit 1200 (\textcircled{1} flow) and moves to the descaling kit unit 1400. The washing water (P) generated by dissolving a descaling material in the purified water (C1) introduced into the descaling kit unit 1400 also passes through the hot water generating unit 1600 and the hot water outlet flow path unit 1700 via the washing water supply flow path unit 1500 and the fourth branch flow path 1140 (\textcircled{2} flow) to remove the scale from the flow path through which the hot water (C2) flows. The washing water (P), which has removed the scale from the flow path through which the hot water (C2) flows, also passes through the cold water generating unit 1800 and the cold water outlet flow path unit 1900 via the washing water supply flow path unit 1500 and the fourth branch flow path 1140 (\textcircled{3} flow) to remove the scale from the flow path through which the cold water (C3) flows. The washing water (P), which has removed the scale from the flow path through which the cold water (C3) flows, is also recovered to the descaling kit unit 1400 and then passes through the purified water outlet flow path unit 1200 via the washing water supply flow path unit 1500 and the fourth branch flow path 1140 (\textcircled{4} [symbol] ) to remove the scale from the flow path through which the purified water (C1) flows.

In this case, the washing water outlet 1410 may be equipped with a separate water outlet valve so that the washing water (P) recovered to the descaling kit unit 1400 can be circulated without being discharged to the washing water outlet 1410. In addition, a separate circulation pump may be provided to generate a circular flow of the washing water (P). That is, the circulation pump is used to circulate the washing water (P) in a state where the raw water valve is blocked so that the raw water (W) is not introduced, and the water outlet valve provided at the washing water outlet 1410 is also blocked. In this case, when the circulation pump is operated while only the hot water valve 1060 is opened, the washing water (P) removes the scale from the hot water generating unit 1600 and the hot water outlet flow path unit 1700 and is then recovered to the descaling kit unit 1400. In addition, when the branch valve 1050 is controlled so that the washing water (P) flows to the cold water generating unit 1800 and the circulation pump is operated while the cold water valve 1080 is opened, the washing water (P) removes the scale from the cold water generating unit 1800 and the cold water outlet flow path unit 1900 and is then recovered to the descaling kit unit 1400. In addition, when the circulation pump is operated while controlling the branch valve 1050 so that the washing water (P) flows to the purified water outlet flow path unit 1200, the washing water (P) removes the scale from the purified water outlet flow path unit 1200 and is then recovered to the descaling kit unit 1400. That is, the washing water (P), which passes through the purified water flow path unit 1100 via the washing water supply flow path unit 1500 and is then recovered to the descaling kit unit 1400, is circulated repeatedly to remove scale, thereby increasing the washing range.

As discussed above, the water purifier according to an embodiment of the present invention is equipped with a separate descaling kit unit 1400 for removing scale, and a water outlet unit 1300 through which the purified water (C1) and hot water (C2) are discharged is detachably coupled to the body casing 1010; whereby the washing water (P) can be generated by separating the water outlet unit 1300 and then installing the descaling kit unit 1400, thereby improving an efficiency of the space inside the water purifier and making it easier to design the layout inside the water purifier; whereby the washing water (P) is produced using the purified water (C1) generated after passing through the filtration unit 1030, thereby improving the cleanliness of the washing water (P) and thus preventing another contamination from occurring during the scale removal process; and whereby the descaling kit unit 1400 can be easily replaced in a manner in which the user directly separates the water outlet unit 1300 from the body casing 1010 and then mounts the descaling kit unit 1400, thereby improving user convenience.

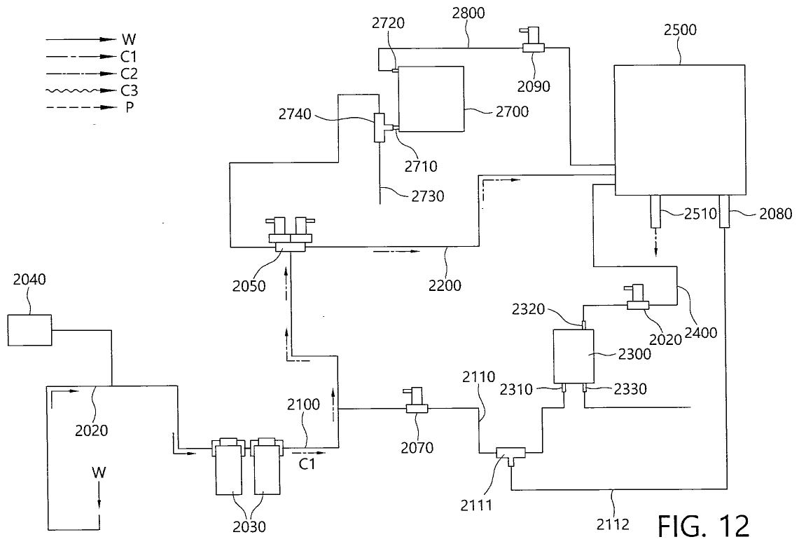

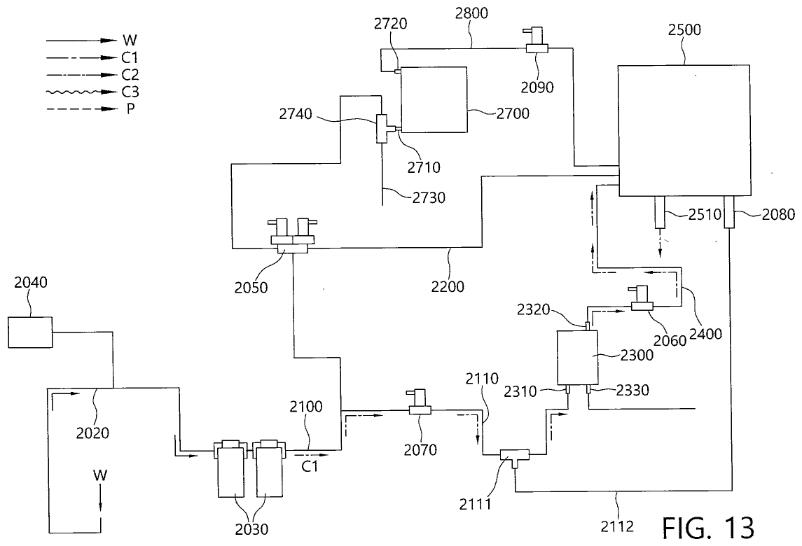

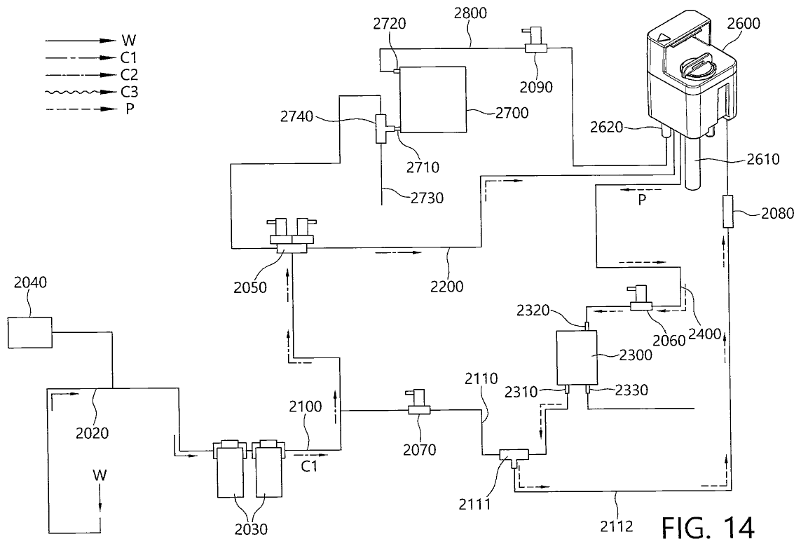

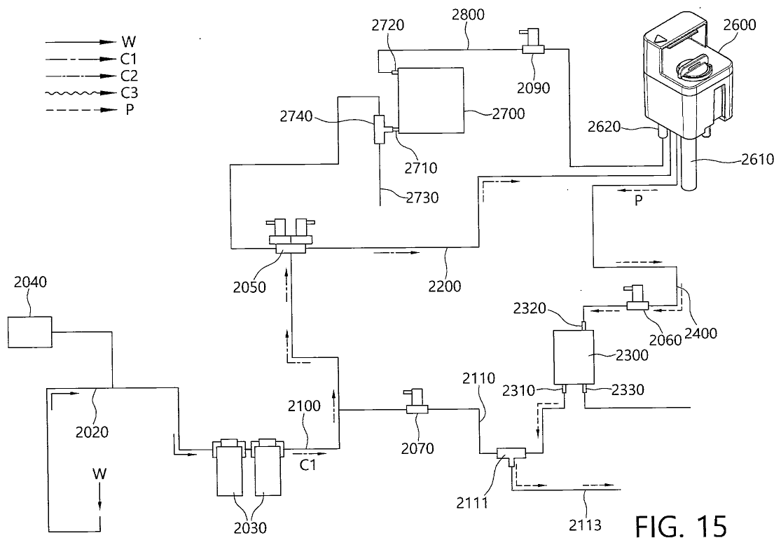

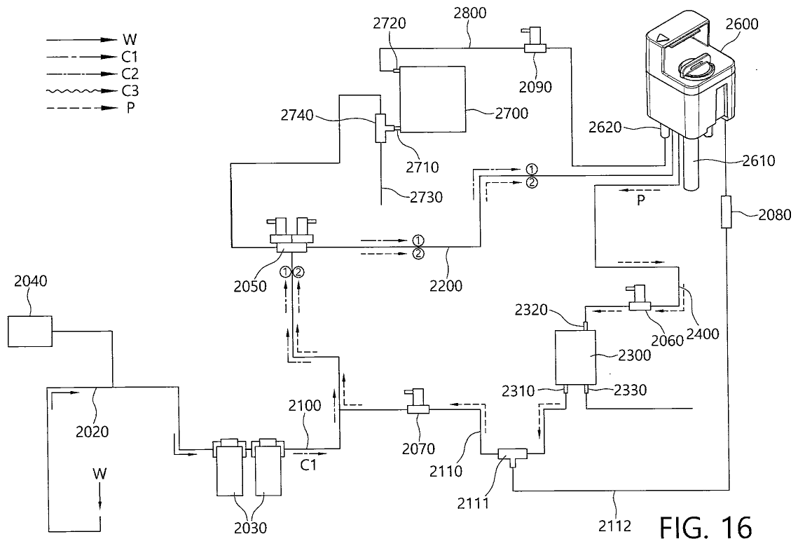

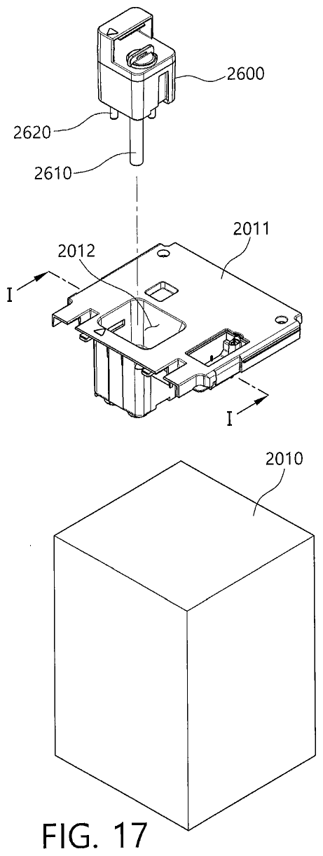

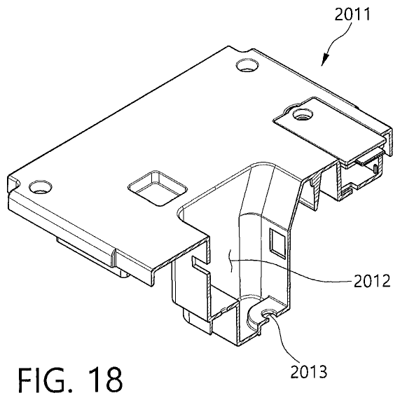

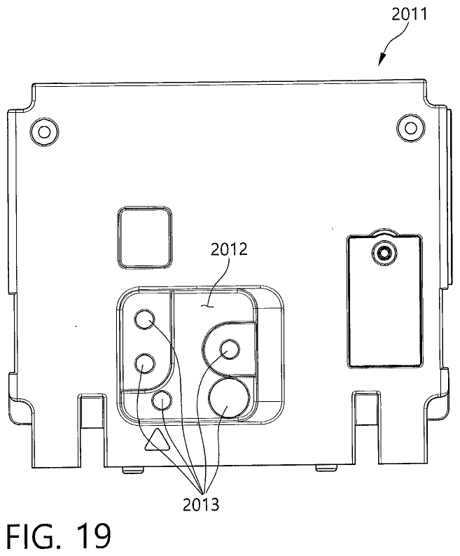

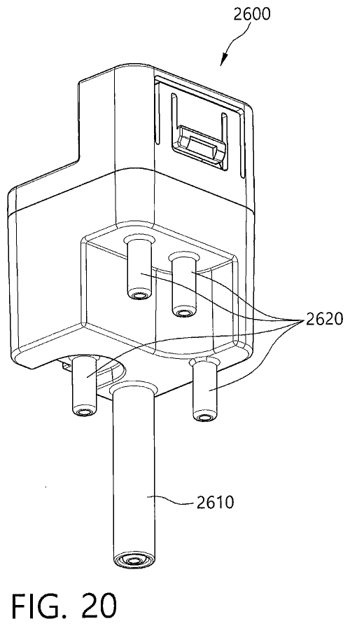

FIG. 12 is a water piping diagram of a water purifier according to an embodiment of the present invention, showing a fluid flow for discharging purified water; FIG. 13 is a water piping diagram of a water purifier according to an embodiment of the present invention, showing a fluid flow for discharging hot water; FIG. 14 is a water piping diagram of a water purifier according to an embodiment of the present invention, showing a flow of washing water sequentially passing through a hot water outlet flow path unit and a hot water generating unit and then being recovered to a descaling kit unit; FIG. 15 is a water piping diagram of a water purifier according to another embodiment of the present invention, showing a flow of washing water sequentially passing through a hot water outlet flow path unit and a hot water generating unit and then being discharged to the outside; FIG. 16 is a water piping diagram of a water purifier according to still another embodiment of the present invention, showing a flow of washing water sequentially passing through a hot water outlet flow path unit, a hot water generating unit and a purified water outlet flow path unit and then being recovered to a descaling kit unit; FIG. 17 is an exploded perspective view of a water purifier according to an embodiment of the present invention; FIG. 18 is a cross-sectional view taken along line I-I in FIG. 17; FIG. 19 is a plan view of an upper cover according to an embodiment of the present invention; and FIG. 20 is a perspective view of a descaling kit unit according to an embodiment of the present invention. In order to clearly describe the present invention, parts irrelevant to the description are omitted from the drawings.

As shown in FIGS. 12 and 13, a water purifier according to an embodiment of the present invention includes: a body casing 2010; a raw water flow path unit 2020 provided in the body casing 2010 and through which introduced raw water (W) flows; a filtration unit 2030 for filtering the raw water (W) to generate purified water (C1); a purified water flow path unit 2100 through which the purified water (C1) flows; a purified water outlet flow path unit 2200 through which the purified water (C1) flows to be discharged to the outside; a hot water generating unit 2300 for heating the purified water (C1) to generate hot water (C2); a hot water outlet flow path unit 2400 through which the hot water (C2) flows so that the hot water (C2) is discharged to the outside; a water outlet unit 2500 detachably coupled to the body casing 2010, connected to each of the purified water outlet flow path unit 2200 and the hot water outlet flow path unit 2400, and provided with a drinking water outlet 2510 so that the purified water (C1) and hot water (C2) are discharged to the outside.

The raw water flow path unit 2020 may be provided with a damping valve for allowing the incoming raw water (W) to flow and reducing the pressure of the incoming raw water (W). Additionally, it may be equipped with a high pressure solenoid valve (NOS valve) for regulating the flow of the raw water (W). The filtration unit 2030 filters the raw water (W) to generate purified water (C1), and may include several filters for this purpose. For example, the filtration unit 2030 may include a pre-carbon filter, a membrane filter, and a post-carbon filter. In addition, the filtration unit 2030 may include an electric deionization type filter. The electric deionization refers to electro deionization (EDI), continuous electro deionization (CEDI), capacitive deionization (CDI), etc. As shown in FIG. 12, the purified water (C1) generated in this way may sequentially pass through the purified water flow path unit 2100 and the purified water outlet flow path unit 2200 and then be provided to a user through the water outlet unit 2500. In this case, the purified water flow path unit 2100 may be provided with a branch valve 2050, and the purified water (C1) moving through the purified water flow path unit 2100 moves to the purified water outlet flow path unit 2200, or a cold water generating unit 2700 which will be described later, through the branch valve 2050. Alternatively, as shown in FIG. 13, the purified water (C1) may sequentially pass through the hot water generating unit 2300 and the hot water outlet flow unit 2400 and then be provided to a user through the water outlet unit 2500. In this case, the hot water outlet flow path unit 2400 may be provided with a hot water valve 2060 for regulating the flow of the hot water (C2). The water outlet unit 2500 may be provided with a drinking water outlet 2510 to allow the purified water (C1) and the hot water (C2) to be discharged. In this case, the purified water outlet flow path unit 2200 and the hot water outlet flow path unit 2400 are not limited to separate tubing or piping, and may be fittings connected to the water outlet unit 2500. In other words, if the tubing or piping through which the purified water (C1) or hot water (C2) flows is collected and modularized inside the water outlet unit 2500, it can be simply installed by connecting the water outlet unit 2500 to the fittings, and if necessary, can also be easily replaced by separating the water outlet unit 2500 from the fittings and replacing it. In this case, the drinking water outlet 2510 provided in the water outlet unit 2500 may be a water outlet faucet for providing the purified water (C1) or hot water (C2) to the user. Alternatively, the drinking water outlet 2510 provided in the water outlet unit 2500 may be a tubing or piping connected to a water outlet faucet provided separately from the water outlet unit 2500. That is, the water outlet unit 2500 may be equipped with only the tubing or piping through which the purified water (C1) or hot water (C2) flows, and the purified water (C1) or hot water (C2) flowing through such tubing or piping may also be provided to the user through a separate water outlet faucet.

As shown in FIGS. 14 to 16, the water purifier may include: a descaling kit unit 2600 detachably coupled to the body casing 2010 so as to be replaceable with the water outlet unit 2500 and provided with an internal flow path to allow washing water (P) to flow to the hot water outlet flow path unit 2400, wherein the washing water (P) is generated by dissolving a descaling material in the purified water (C1) introduced through the purified water outlet flow path unit 2200; and a control unit 2040 for controlling fluid flow in each of the units.

As shown in FIGS. 17 to 20, the body casing 2010 provides an internal space in which various parts constituting the water purifier are accommodated, and may be formed in a hexahedral shape, but is not necessarily limited to this shape as long as an internal space capable of accommodating the above-mentioned parts is formed. The body casing 2010 may be provided with an upper cover 2011 for opening and closing the internal space, wherein the upper cover 2011 is configured to be provided with a seating groove 2012 to which the water outlet unit 2500 is detachably coupled, so that the purified water (C1) or hot water (C2) is discharged to the outside through the water outlet unit 2500. The descaling kit unit 2600 may also be detachably coupled to the seating groove 2012 provided in the upper cover 2011 of the body casing 2010, and may be provided with an internal flow path to allow the washing water (P) to flow to the hot water outlet flow path unit 2400, wherein the washing water (P) is generated by dissolving a descaling material in the purified water introduced through the purified water outlet flow path unit 2200. The descaling kit unit 2600 may be provided with a scale storage space that accommodates the washing water (P) recovered after scale removal, and the washing water (P) accommodated in this scale storage space may be discharged to the outside through the washing water outlet 2610. In addition, the descaling kit unit 2600 may be provided with an accommodation space in which the purified water (C1) is accommodated, wherein the accommodation space communicates with each of the flow paths through which the purified water (C1), hot water (C2), and cold water (C3) flow, and a washing water port 2620 may be provided so that each of these flow paths communicates with the accommodation space. The accommodation space may be a scale storage space in which the recovered washing water (P) is accommodated. The seating groove 2012 provided in the upper cover 2011 of the body casing 2010 may be provided with a port hole 2013 through which the washing water port 2620 passes and is coupled. The control unit 2040 can control the flow of the washing water (P) as well as the flows of the purified water (C1) and hot water (C2) flowing through each flow path.

That is, the water purifier is equipped with a separate descaling kit unit 2600 for removing scale, and a water outlet unit 2500 through which the purified water (C1) and hot water (C2) are discharged is detachably coupled to the body casing 2010; whereby the washing water (P) can be generated by separating the water outlet unit 2500 and then installing the descaling kit unit 2600, thereby improving an efficiency of the space inside the water purifier and making it easier to design the layout inside the water purifier; whereby the washing water (P) is produced using the purified water (C1) generated after passing through the filtration unit 2030, thereby improving the cleanliness of the washing water (P) and thus preventing another contamination from occurring during the scale removal process; and whereby the descaling kit unit 2600 can be easily replaced in a manner in which the user directly separates the water outlet unit 2500 from the body casing 2010 and then mounts the descaling kit unit 2600, thereby improving user convenience.

As shown in FIG. 14, in the water purifier according to an embodiment of the present invention, the control unit 2040 may control the flow of the washing water (P) so that the washing water (P) sequentially passes through the hot water outlet flow path unit 2400 and the hot water generating unit 2300. That is, the hot water (C2) generated through the hot water generating unit 2300 moves to the water outlet unit 2500 via the hot water outlet flow path unit 2400, whereas the washing water (P) generated by dissolving a descaling material in the purified water (C1) introduced into the descaling kit unit 2600 sequentially passes through the hot water outlet flow path unit 2400 and the hot water generating unit 2300 (in a direction opposite to the hot water flow direction) to remove the scale, thereby improving the cleanliness of the water purifier. In this case, when the hot water valve 2060 is opened so that the washing water (P) moves to the hot water outlet flow path unit 2400 and the hot water generating unit 2300, the pressure of the raw water (W) can be transmitted to the washing water (P) through the purified water (C1), allowing the washing water (P) to flow smoothly.

As shown in FIG. 14, in the water purifier according to an embodiment of the present invention, the hot water generating unit 2300 may include a first purified water inlet port 2310 connected to the purified water flow path unit 2100, and a hot water outlet port 2320 connected to the hot water outlet flow path unit 2400; and the control unit 2040 may control the washing water (P) to flow into the hot water outlet port 2320 and then flow out through the first purified water inlet port 2310. This hot water generating unit 2300 may be provided with a hot water housing in which the purified water (C1) is accommodated, and the purified water moves into the hot water housing through the first purified water inlet port 2310 connected to the purified water flow path unit 2100. The hot water (C2) heated inside the hot water housing moves out of the hot water housing through the hot water outlet port 2320 connected to the hot water outlet flow path unit 2400. The hot water generating unit 2300 may be equipped with a heater for heating the purified water (C1) stored inside the hot water housing, and a water level detection sensor for detecting the water level of the purified water (C1) stored inside the hot water housing. For example, the heater may be a plate type heater, but is not necessarily limited thereto, and any configuration may be used as long as it can heat the purified water (C1) stored in the hot water housing. In the plate type heater, the packaging efficiency can be improved by being formed to extend along the side wall of the hot water housing, and the heating capacity can be changed by adjusting the power supplied to the plate type heater. In addition, the hot water generating unit 2300 may be provided with a separate hot water drain port 2330, and can be configured to discharge the washing water (P) to the outside through the hot water drain port 2330.

That is, the purified water (C1) moves into the hot water housing through the first purified water inlet port 2310 in order to generate hot water (C2), and the hot water (C2) generated by heating the purified water (C1) moves out of the hot water housing through the hot water outlet port 2320. However, the washing water (P) generated by dissolving a descaling material in the purified water (C1) introduced into the descaling kit unit 2600 flows into the hot water outlet port 2320 of the hot water generating unit 2300 to remove scale inside the hot water generating unit 2300, and then flows out through the first purified water inlet port 2310 (in a direction opposite to the hot water flow direction), whereby it is possible to effectively remove the scale from the hot water generating unit 2300, and an operational stability during the scale removal process is improved through the smooth flow of the washing water (P).

As shown in FIG. 14, in the water purifier according to an embodiment of the present invention, the purified water flow path unit 2100 includes a first purified water flow path member 2110 connected to the first purified water inlet port 2310, wherein the first purified water flow path member 2110 may be connected to a first branch flow path 2111 through which the washing water (P) discharged to the first purified water inlet port 2310 flows. Here, the first purified water flow path member 2110 may be provided with a flow control valve 2070 for controlling the flow rate of the purified water (C1) moving to the hot water generating unit 2300. That is, since the washing water (P) flowing through the first purified water inlet port 2310 flows to the first branch flow path 2111 through the first purified water flow path member 2110, the washing water (P) is discharged smoothly without flowing back to the filtration unit 2030, thereby improving an operational stability during the scale removal process.

As shown in FIG. 14, in the water purifier according to an embodiment of the present invention, the first branch flow path 2111 may be connected to the first scale storage flow path 2112 that communicates with the scale storage space provided in the descaling kit unit 2600. In this case, the first scale storage flow path 2112 may be provided with a check valve 2080 for preventing the washing water (P) moving to the descaling kit unit 2600 from flowing back. In addition, as described above, if the drinking water outlet 2510 provided in the water outlet unit 2500 is a water outlet faucet for providing the purified water (C1) or hot water (C2) to the user, the descaling kit unit 2600, which is replaced with the water outlet unit 2500, may also be provided with a washing water outlet 2610 for discharging the washing water (P) as well as the tubing or piping. That is, the washing water (P) flowing through the first branch flow path 2111 is discharged to the scale storage space of the descaling kit unit 2600 through the first scale storage flow path 2112, and thus scale can be discharged even in a situation where discharge to the outside is impossible, thereby ensuring the operational stability of the water purifier and improving user convenience. In addition, as described above, the washing water (P) accommodated in the scale storage space may also be discharged to the outside through the washing water outlet 2610.

As shown in FIG. 15, in the water purifier according to another embodiment of the present invention, the first branch flow path 2111 may be connected to a first scale discharge flow path 2113 that communicates with the outside so that the washing water (P) is discharged to the outside. As described above, as the water outlet faucet is provided separately from the water outlet unit 2500, if the water outlet unit 2500 is provided with only tubing or piping, the descaling kit unit 2600, which is replaced with the water outlet unit 2500, may also be provided with only tubing or piping. In this case, the washing water (P) is discharged to the outside through the first scale discharge flow path 2113. That is, the washing water (P) flowing through the first branch flow path 2111 is discharged to the outside through the first scale discharge flow path 2113, thereby ensuring the operational stability of the water purifier and improving user convenience.

As shown in FIG. 16, in the water purifier according to still another embodiment of the present invention, the control unit 2040 may control the flow of the washing water (P) so that the washing water (P) sequentially passes through the hot water outlet flow path unit 2400 and the hot water generating unit 2300, and then is recovered to the descaling kit unit 2600 via the purified water outlet flow path unit 2200. As described above, the purified water (C1) generated through the filtration unit 2030 passes sequentially through the purified water flow path unit 2100 and the purified water outlet flow path unit 2200 (\textcircled{1} flow) and moves to the descaling kit unit 2600. The washing water (P) generated by dissolving a descaling material in the purified water (C1) introduced into the descaling kit unit 2600 sequentially passes through the hot water outlet flow path unit 2400 and the hot water generating unit 2300 (in a direction opposite to the hot water flow direction) to remove the scale, and this washing water (P) also sequentially passes through the purified water flow path unit 2100 and the purified water outlet flow path unit 2200 (0 flow) to remove scale from the flow path through which the purified water (C1) flows. That is, the washing water (P) passes through not only the hot water outlet flow path unit 2400 and the hot water generating unit 2300, but also the purified water outlet flow path unit 2200 to remove scale from the flow path of the purified water (C1), thereby improving the cleanliness of the water purifier. In addition, when the washing water (P) is heated using the hot water generating unit 2300, the performance of removing scale from the hot water (C2) flow path and the purified water (C1) flow path is improved.

As shown in FIG. 14, in the water purifier according to an embodiment of the present invention, the control unit 2040 may control the flow of the washing water (P) so that the washing water (P), which passes sequentially through the hot water outlet flow path unit 2400 and the hot water generating unit 2300 and is then recovered to the descaling kit unit 2600, is circulated repeatedly to remove scale. That is, as described above, the washing water (P) generated by dissolving a descaling material in the purified water (C1) introduced into the descaling kit unit 2600 sequentially passes through the hot water outlet flow path unit 2400 and the hot water generating unit 2300 to remove the scale. This washing water (P) is configured to remove scale while circulating in such a way that it moves back to the hot water outlet flow path unit 2400 and the hot water generating unit 2300. In this case, the washing water outlet 2610 may be equipped with a separate water outlet valve so that the washing water (P) recovered to the descaling kit unit 2600 can be circulated without being discharged to the washing water outlet 2610. In addition, a separate circulation pump may be provided to generate a circular flow of the washing water (P). That is, the circulation pump is used to circulate the washing water (P) in a state where the raw water valve is blocked so that the raw water (W) is not introduced, and the water outlet valve provided at the washing water outlet 2610 is also blocked. In this case, when the circulation pump is operated while only the hot water valve 2060 is opened, the washing water (P), which passes through the hot water outlet flow path unit 2400 and the hot water generating unit 2300 and is then recovered to the descaling kit unit 2600, is circulated repeatedly to remove scale, thereby increasing the washing range. In addition, when the circulation pump is operated while not only the hot water valve 2060 but also the branch valve 2050 is opened, the washing water (P), which passes through not only the hot water outlet flow path unit 2400 and the hot water generating unit 2300, but also the purified water outlet flow path unit 2200 and is then recovered to the descaling kit unit 2600, is circulated repeatedly to remove scale, thereby increasing the washing range.

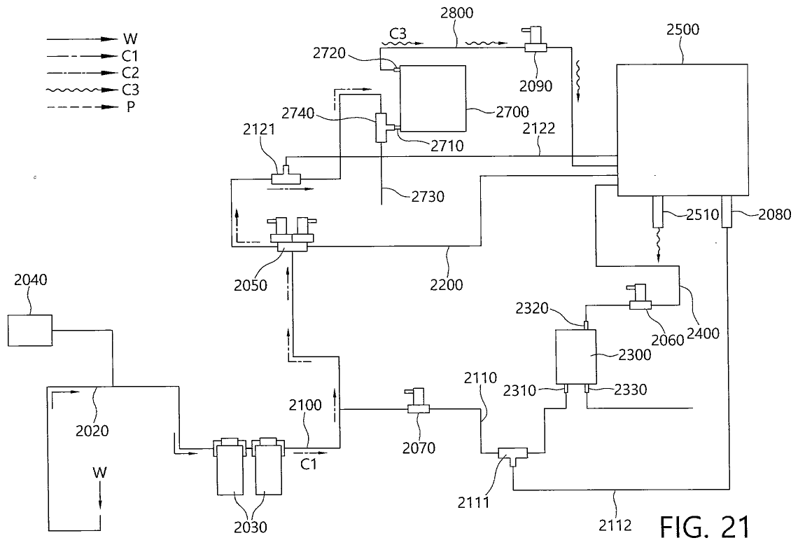

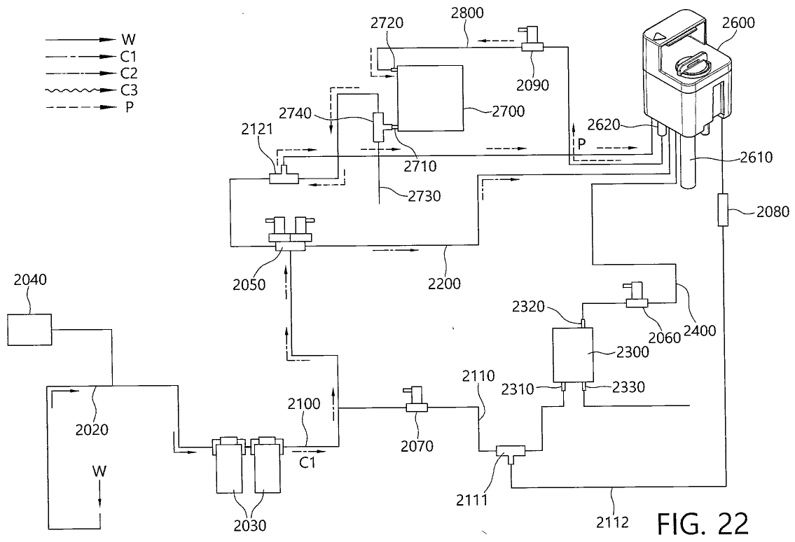

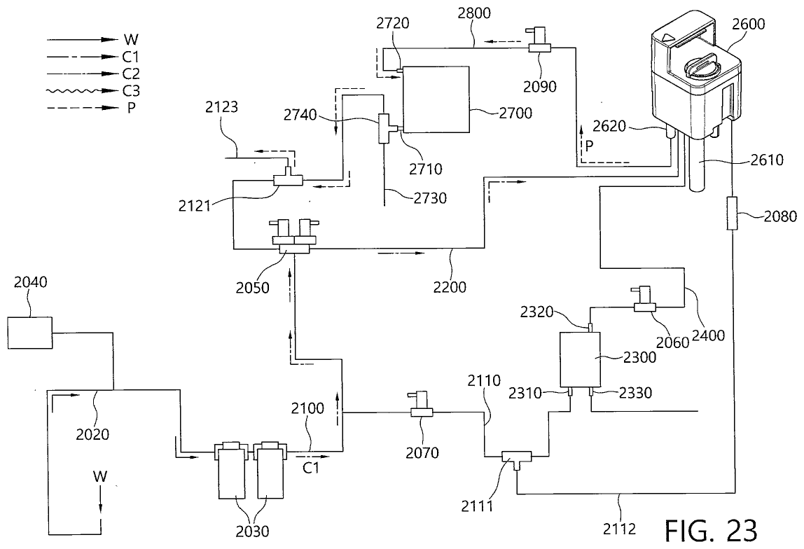

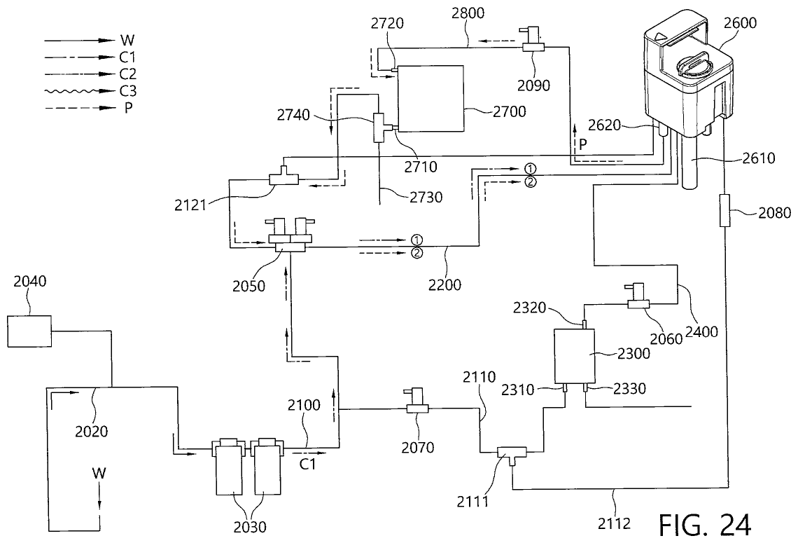

FIG. 21 is a water piping diagram of a water purifier according to still another embodiment of the present invention, showing a fluid flow for discharging cold water; FIG. 22 is a water piping diagram of a water purifier according to still another embodiment of the present invention, showing a flow of washing water sequentially passing through a cold water outlet flow path unit and a cold water generating unit and then being recovered to a descaling kit unit; FIG. 23 is a water piping diagram of a water purifier according to still another embodiment of the present invention, showing a flow of washing water sequentially passing through a cold water outlet flow path unit and a cold water generating unit and then being discharged to the outside; and FIG. 24 is a water piping diagram of a water purifier according to still another embodiment of the present invention, showing a flow of washing water sequentially passing through a cold water outlet flow path unit, a cold water generating unit and a purified water outlet flow path unit and then being recovered to a descaling kit unit.

As shown in FIG. 21, a water purifier according to still another embodiment of the present invention includes: a body casing 2010; a raw water flow path unit 2020 provided in the body casing 2010 and through which introduced raw water (W) flows; a filtration unit 2030 for filtering the raw water (W) to generate purified water (C1); a purified water flow path unit 2100 through which the purified water (C1) flows; a purified water outlet flow path unit 2200 through which the purified water (C1) flows to be discharged to the outside; a cold water generating unit 2700 for cooling the purified water (C1) to generate cold water (C3); a cold water outlet flow path unit 2800 through which the cold water (C3) flows so that the cold water (C3) is discharged to the outside; a water outlet unit 2500 detachably coupled to the body casing 2010, connected to each of the purified water outlet flow path unit 2200 and the cold water outlet flow path unit 2800, and provided with a drinking water outlet 2510 so that the purified water (C1) and cold water (C3) are discharged to the outside. In this case, the body casing 2010, the raw water flow path unit 2020, the filtration unit 2030 and the water outlet unit 2500 may have the same configuration as described above. The purified water (C1) supplied through the purified water flow path unit 2100 is cooled through the cold water generating unit 2700, and the generated cold water (C3) may move to the water outlet unit 2500 through the cold water outlet flow path unit 2800 and then be provided to the user. The cold water outlet flow path unit 2800 may be provided with a cold water valve 2090 for regulating the flow of the cold water (C3). The water outlet unit 2500 may be provided with a drinking water outlet 2510 to allow the purified water (C1) and the cold water (C3) to be discharged. In this case, the cold water outlet flow path unit 2800 are not limited to separate tubing or piping, and may be fittings connected to the water outlet unit 2500. In other words, if the tubing or piping through which the purified water (C1) or cold water (C3) flows is collected and modularized inside the water outlet unit 2500, it can be simply installed by connecting the water outlet unit 2500 to the fittings, and if necessary, can also be easily replaced by separating the water outlet unit 2500 from the fittings and replacing it. In this case, the drinking water outlet 2510 provided in the water outlet unit 2500 may be a water outlet faucet for providing the purified water (C1) and cold water (C3) to the user. Alternatively, the drinking water outlet 2510 provided in the water outlet unit 2500 may be a tubing or piping connected to a water outlet faucet provided separately from the water outlet unit 2500. That is, the water outlet unit 2500 may be equipped with only the tubing or piping through which the purified water (C1) or cold water (C3) flows, and the purified water (C1) or cold water (C3) flowing through such tubing or piping may also be provided to the user through a separate water outlet faucet.

As shown in FIG. 22, the water purifier may include: a descaling kit unit 2600 detachably coupled to the body casing 2010 so as to be replaceable with the water outlet unit 2500 and provided with an internal flow path to allow washing water (P) to flow to the cold water outlet flow path unit 2800, wherein the washing water (P) is generated by dissolving a descaling material in the purified water (C1) introduced through the purified water outlet flow path unit 2200; and a control unit 2040 for controlling fluid flow in each of the units. Here, the descaling kit unit 2600 may have the same configuration as previously described.

That is, the water purifier is equipped with a separate descaling kit unit 2600 for removing scale, and a water outlet unit 2500 through which the purified water (C1) and cold water (C3) are discharged is detachably coupled to the body casing 2010; whereby the washing water (P) can be generated by separating the water outlet unit 2500 and then installing the descaling kit unit 2600, thereby improving an efficiency of the space inside the water purifier and making it easier to design the layout inside the water purifier; whereby the washing water (P) is produced using the purified water (C1) generated after passing through the filtration unit 2030, thereby improving the cleanliness of the washing water (P) and thus preventing another contamination from occurring during the scale removal process; and whereby the descaling kit unit 2600 can be easily replaced in a manner in which the user directly separates the water outlet unit 2500 from the body casing 2010 and then mounts the descaling kit unit 2600, thereby improving user convenience.

As shown in FIG. 22, in the water purifier according to still another embodiment of the present invention, the control unit 2040 may control the flow of the washing water (P) so that the washing water (P) sequentially passes through the cold water outlet flow path unit 2800 and the cold water generating unit 2700. That is, the cold water (C3) generated through the cold water generating unit 2700 moves to the water outlet unit 2500 via the cold water outlet flow path unit 2800, whereas the washing water (P) generated by dissolving a descaling material in the purified water (C1) introduced into the descaling kit unit 2600 sequentially passes through the cold water outlet flow path unit 2800 and the cold water generating unit 2700 (in a direction opposite to the cold water flow direction) to remove the scale, thereby improving the cleanliness of the water purifier. In this case, when the cold water valve 2090 is opened so that the washing water (P) moves to the cold water outlet flow path unit 2800 and the cold water generating unit 2700, the pressure of the raw water (W) can be transmitted to the washing water (P) through the purified water (C1), allowing the washing water (P) to flow smoothly.

As shown in FIG. 22, in the water purifier according to still another embodiment of the present invention, the cold water generating unit 2700 may include a second purified water inlet port 2710 connected to the purified water flow path unit 2100, and a cold water outlet port 2720 connected to the cold water outlet flow path unit 2800; and the control unit 2040 may control the washing water (P) to flow into the cold water outlet port 2720 and then flow out through the second purified water inlet port 2710. This cold water generating unit 2700 may be provided with a cold water housing in which the purified water (C1) is accommodated, and the purified water moves into the cold water housing through the second purified water inlet port 2710 connected to the purified water flow path unit 2100. The cold water (C3) heated inside the cold water housing moves out of the cold water housing through the cold water outlet port 2720 connected to the cold water outlet flow path unit 2800. The cold water generating unit 2700 may be equipped with a cooling member for cooling the purified water (C1) stored inside the cold water housing, and a water level detection sensor for detecting the water level of the purified water (C1) stored inside the cold water housing. For example, the cooling member may be a cooling coil through which low-temperature refrigerant flows, or a thermoelectric module that cools the purified water (C1) using a thermoelectric element, but is not necessarily limited thereto, and any configuration may be used as long as it can cool the purified water (C1) stored in the cold water housing. In addition, the cold water generating unit 2700 may be provided with a separate cold water drain port 2730, and can be configured to discharge the washing water (P) to the outside through the cold water drain port 2730. The cold water generating unit 2700 may be provided with a cold water branch flow path 2740 connecting the purified water flow path unit 2100 and the cold water drain port 2730.

That is, the purified water (C1) moves into the cold water housing through the second purified water inlet port 2710 in order to generate cold water (C3), and the cold water (C3) generated by cooling the purified water (C1) moves out of the cold water housing through the cold water outlet port 2720. However, the washing water (P) generated by dissolving a descaling material in the purified water (C1) introduced into the descaling kit unit 2600 flows into the cold water outlet port 2720 of the cold water generating unit 2700 to remove scale inside the cold water generating unit 2700, and then flows out through the second purified water inlet port 2710 (in a direction opposite to the cold water flow direction), whereby it is possible to effectively remove the scale from the cold water generating unit 2700, and an operational stability during the scale removal process is improved through the smooth flow of the washing water (P).

As shown in FIG. 22, in the water purifier according to still another embodiment of the present invention, the purified water flow path unit 2100 includes a second purified water flow path member 2120 connected to the second purified water inlet port 2710, wherein the second purified water flow path member 2120 may be connected to a second branch flow path 2121 through which the washing water (P) discharged to the second purified water inlet port 2710 flows. That is, since the washing water (P) flowing through the second purified water inlet port 2710 flows to the second branch flow path 2121 through the second purified water flow path member 2120, the washing water (P) is discharged smoothly without flowing back to the filtration unit 2030, thereby improving an operational stability during the scale removal process.

As shown in FIG. 22, in the water purifier according to still another embodiment of the present invention, the second branch flow path 2121 may be connected to the second scale storage flow path 2122 that communicates with the scale storage space provided in the descaling kit unit 2600. In this case, the second scale storage flow path 2122 may be provided with a check valve for preventing the washing water (P) moving to the descaling kit unit 2600 from flowing back. In addition, as described above, if the drinking water outlet 2510 provided in the water outlet unit 2500 is a water outlet faucet for providing the purified water (C1) or cold water (C3) to the user, the descaling kit unit 2600, which is replaced with the water outlet unit 2500, may also be provided with a washing water outlet 2610 for discharging the washing water (P) as well as the tubing or piping. That is, the washing water (P) flowing through the second branch flow path 2121 is discharged to the scale storage space of the descaling kit unit 2600 through the second scale storage flow path 2122, and thus scale can be discharged even in a situation where discharge to the outside is impossible, thereby ensuring the operational stability of the water purifier and improving user convenience. In addition, as described above, the washing water (P) accommodated in the scale storage space may also be discharged to the outside through the washing water outlet 2610.

As shown in FIG. 23, in the water purifier according to still another embodiment of the present invention, the second branch flow path 2121 may be connected to a second scale discharge flow path 2123 that communicates with the outside so that the washing water (P) is discharged to the outside. As described above, as the water outlet faucet is provided separately from the water outlet unit 2500, if the water outlet unit 2500 is provided with only tubing or piping, the descaling kit unit 2600, which is replaced with the water outlet unit 2500, may also be provided with only tubing or piping. In this case, the washing water (P) is discharged to the outside through the second scale discharge flow path 2123. That is, the washing water (P) flowing through the second branch flow path 2121 is discharged to the outside through the second scale discharge flow path 2123, thereby ensuring the operational stability of the water purifier and improving user convenience.

As shown in FIG. 24, in the water purifier according to still another embodiment of the present invention, the control unit 2040 may control the flow of the washing water (P) so that the washing water (P) sequentially passes through the cold water outlet flow path unit 2800 and the cold water generating unit 2700, and then is recovered to the descaling kit unit 2600 via the purified water outlet flow path unit 2200. As described above, the purified water (C1) generated through the filtration unit 2030 passes sequentially through the purified water flow path unit 2100 and the purified water outlet flow path unit 2200 (\textcircled{1} flow) and moves to the descaling kit unit 2600. The washing water (P) generated by dissolving a descaling material in the purified water (C1) introduced into the descaling kit unit 2600 sequentially passes through the cold water outlet flow path unit 2800 and the cold water generating unit 2700 (in a direction opposite to the cold water flow direction) to remove the scale, and this washing water (P) also sequentially passes through the purified water flow path unit 2100 and the purified water outlet flow path unit 2200 (0 flow) to remove scale from the flow path through which the purified water (C1) flows. That is, the washing water (P) passes through not only the cold water outlet flow path unit 2800 and the cold water generating unit 2700, but also the purified water outlet flow path unit 2200 to remove scale from the flow path of the purified water (C1), thereby improving the cleanliness of the water purifier.

As shown in FIG. 22, in the water purifier according to an embodiment of the present invention, the control unit 2040 may control the flow of the washing water (P) so that the washing water (P), which passes sequentially through the cold water outlet flow path unit 2800 and the cold water generating unit 2700 and is then recovered to the descaling kit unit 2600, is circulated repeatedly to remove scale. That is, as described above, the washing water (P) generated by dissolving a descaling material in the purified water (C1) introduced into the descaling kit unit 2600 sequentially passes through the cold water outlet flow path unit 2800 and the cold water generating unit 2700 to remove the scale. This washing water (P) is configured to remove scale while circulating in such a way that it moves back to the cold water outlet flow path unit 2800 and the cold water generating unit 2700. In this case, the washing water outlet 2610 may be equipped with a separate water outlet valve so that the washing water (P) recovered to the descaling kit unit 2600 can be circulated without being discharged to the washing water outlet 2610. In addition, a separate circulation pump may be provided to generate a circular flow of the washing water (P). That is, the circulation pump is used to circulate the washing water (P) in a state where the raw water valve is blocked so that the raw water (W) is not introduced, and the water outlet valve provided at the washing water outlet 2610 is also blocked. In this case, when the circulation pump is operated while only the cold water valve 2090 is opened, the washing water (P), which passes through the cold water outlet flow path unit 2800 and the cold water generating unit 2700 and is then recovered to the descaling kit unit 2600, is circulated repeatedly to remove scale, thereby increasing the washing range. In addition, when the circulation pump is operated while not only the cold water valve 2090 but also the branch valve 2050 is opened, the washing water (P), which passes through not only the cold water outlet flow path unit 2800 and the cold water generating unit 2700, but also the purified water outlet flow path unit 2200 and is then recovered to the descaling kit unit 2600, is circulated repeatedly to remove scale, thereby increasing the washing range.

As discussed above, the water purifier according to an embodiment of the present invention is equipped with a separate descaling kit unit 2600 for removing scale, and a water outlet unit 2500 through which the purified water (C1) and hot water (C2) are discharged is detachably coupled to the body casing 2010; whereby the washing water (P) can be generated by separating the water outlet unit 2500 and then installing the descaling kit unit 2600, thereby improving an efficiency of the space inside the water purifier and making it easier to design the layout inside the water purifier; whereby the washing water (P) is produced using the purified water (C1) generated after passing through the filtration unit 2030, thereby improving the cleanliness of the washing water (P) and thus preventing another contamination from occurring during the scale removal process; and whereby the descaling kit unit 2600 can be easily replaced in a manner in which the user directly separates the water outlet unit 2500 from the body casing 2010 and then mounts the descaling kit unit 2600, thereby improving user convenience.

Although an embodiment of the present invention have been described above, the spirit of the present invention is not limited to the embodiment presented in the subject specification; and those skilled in the art who understands the spirit of the present invention will be able to easily suggest other embodiments through addition, changes, elimination, and the like of elements without departing from the scope of the same spirit, and such other embodiments will also fall within the scope of the present invention.

### DESCRIPTION OF REFERENCE NUMERALS AND SYMBOLS

1010: body casing
1011: upper cover
1012: seating groove
1013: port hole
1020: raw water flow path unit
1030: filtration unit
1040: control unit
1050: branch valve
1060: hot water valve
1070: flow control valve
1080: cold water valve
1100: purified water flow path unit
1110: first purified water flow path unit
1111: first branch flow path
1120: second purified water flow path unit
1121: second branch flow path
1122: second scale storage flow path
1123: second scale discharge flow path
1130: third purified water flow path unit
1131: third branch flow path
1140: fourth branch flow path
1200: purified water outlet flow path unit
1300: water outlet unit
1310: drinking water outlet
1330: hot water drain port
1400: descaling kit unit
1410: washing water outlet
1420: washing water port
1500: washing water supply flow path unit
1600: hot water generating unit
1610: first purified water inlet port
1620: hot water outlet port
1700: hot water outlet flow path unit
1800: cold water generating unit
1810: second purified water inlet port
1820: cold water outlet port
1830: cold water drain port
1840: cold water branch flow path
1900: cold water outlet flow path unit
2010: body casing
2011: upper cover
2012: seating groove
2013: port hole
2020: raw water flow path unit
2030: filtration unit
2040: control unit
2050: branch valve
2060: hot water valve
2070: flow control valve
2080: check valve
2090: cold water valve
2100: purified water flow path unit
2110: first purified water flow path member
2111: first branch flow path
2112: first scale storage flow path
2113: first scale discharge flow path
2120: second purified water flow path member
2121: second branch flow path
2122: second scale storage flow path
2123: second scale discharge flow path
2200: purified water outlet flow path unit
2300: hot water generating unit
2310: first purified water inlet port
2320: hot water outlet port
2330: hot water drain port
2400: hot water outlet flow path unit
2500: water outlet unit
2510: drinking water outlet
2600: descaling kit unit
2610: washing water outlet
2620: washing water port
2700: cold water generating unit
2710: second purified water inlet port
2720: cold water outlet port
2730: cold water drain port
2740: cold water branch flow path
2800: cold water outlet flow path unit
C1: purified water
C2: hot water
C3: cold water
P: washing water
W: raw water

1. A water purifier including:
a body casing;
a raw water flow path unit provided in the body casing and through which introduced raw water flows;
a filtration unit for filtering the raw water to generate purified water;
a purified water flow path unit through which the purified water flows;
a purified water outlet flow path unit through which the purified water flows to be discharged to the outside;
a water outlet unit detachably coupled to the body casing, connected to the purified water outlet flow path unit, and provided with a drinking water outlet to allow the purified water to be discharged to the outside;
a descaling kit unit detachably coupled to the body casing so as to be replaceable with the water outlet unit and provided with an internal flow path to allow washing water to flow to the purified water flow path unit, wherein the washing water is generated by dissolving a descaling material in the purified water introduced through the purified water outlet flow path unit; and
a control unit for controlling fluid flow in each of the units.

2. The water purifier according to claim 1, wherein the water purifier further includes a washing water supply flow path unit connecting the descaling kit unit and the purified water flow path unit so that the washing water flows to the purified water flow path unit.

3. The water purifier according to claim 2, wherein the water purifier further includes: a hot water generating unit for heating the purified water to generate hot water; and a hot water outlet flow path unit through which the hot water flows to be discharged to the outside,
wherein the purified water flow path unit comprises a first purified water flow path member connected to the hot water generating unit, and
wherein the washing water supply flow path unit is connected to the first purified water flow path member so that the washing water flows to the hot water generating unit.

4. The water purifier according to claim 3, wherein the hot water generating unit includes a first purified water inlet port connected to the first purified water flow path member, and a hot water outlet port connected to the hot water outlet flow path unit; and
the control unit controls the washing water to flow into the first purified water inlet port and then flow out through the hot water outlet port.

5. The water purifier according to claim 2, wherein the water purifier further includes: a cold water generating unit for cooling the purified water to generate cold water; and a cold water outlet flow path unit through which the cold water flows to be discharged to the outside,
wherein the purified water flow path unit comprises a second purified water flow path member connected to the cold water generating unit, and
wherein the washing water supply flow path unit is connected to the second purified water flow path member so that the washing water flows to the cold water generating unit.

6. The water purifier according to claim 5, wherein the cold water generating unit includes a second purified water inlet port connected to the second purified water flow path member, and a cold water outlet port connected to the cold water outlet flow path unit; and
the control unit controls the washing water to flow into the second purified water inlet port and then flow out through the cold water outlet port.

7. The water purifier according to claim 2, wherein the purified water flow path unit comprises a third purified water flow path member connected to the purified water outlet flow path unit; and
the washing water supply flow path unit is connected to the third purified water flow path member so that the washing water flows to the purified water outlet flow path unit.

8. The water purifier according to claim 2, wherein the control unit controls the flow of the washing water so that the washing water, which passes through the washing water supply flow path unit to the purified water flow path unit and is then recovered to the descaling kit unit, is circulated repeatedly to remove scale.

9. A water purifier including:
a body casing;
a raw water flow path unit provided in the body casing and through which introduced raw water flows;
a filtration unit for filtering the raw water to generate purified water;
a purified water flow path unit through which the purified water flows;
a purified water outlet flow path unit through which the purified water flows to be discharged to the outside;
a hot water generating unit for heating the purified water to generate hot water;
a hot water outlet flow path unit through which the hot water flows to be discharged to the outside;
a water outlet unit detachably coupled to the body casing, connected to each of the purified water outlet flow path unit and the hot water outlet flow path unit, and provided with a drinking water outlet to allow the purified water and hot water to be discharged to the outside;
a descaling kit unit detachably coupled to the body casing so as to be replaceable with the water outlet unit and provided with an internal flow path to allow washing water to flow to the hot water outlet flow path unit, wherein the washing water is generated by dissolving a descaling material in the purified water introduced through the purified water outlet flow path unit; and
a control unit for controlling fluid flow in each of the units.

10. The water purifier according to claim 9, wherein the control unit controls the flow of the washing water so that the washing water sequentially passes through the hot water outlet flow path unit and the hot water generating unit.

11. The water purifier according to claim 10, wherein the hot water generating unit includes a first purified water inlet port connected to the purified water flow path unit, and a hot water outlet port connected to the hot water outlet flow path unit; and
the control unit controls the washing water to flow into the hot water outlet port and then flow out through the first purified water inlet port.

12. The water purifier according to claim 11, wherein the purified water flow path unit includes a first purified water flow path member connected to the first purified water inlet port, and
the first purified water flow path member is connected to a first branch flow path through which the washing water discharged to the first purified water inlet port flows.

13. The water purifier according to claim 10, wherein the control unit controls the flow of the washing water so that the washing water, which sequentially passes through the hot water outlet flow path unit and the hot water generating unit, is recovered to the descaling kit unit via the purified water outlet flow path unit.

14. The water purifier according to claim 10, wherein the control unit controls the flow of the washing water so that the washing water, which passes sequentially through the hot water outlet flow path unit and the hot water generating unit and is then recovered to the descaling kit unit, is circulated repeatedly to remove scale.

15. A water purifier including:
a body casing;
a raw water flow path unit provided in the body casing and through which introduced raw water flows;
a filtration unit for filtering the raw water to generate purified water;
a purified water flow path unit through which the purified water flows;
a purified water outlet flow path unit through which the purified water flows to be discharged to the outside;
a cold water generating unit for cooling the purified water to generate cold water;
a cold water outlet flow path unit through which the cold water flows to be discharged to the outside;
a water outlet unit detachably coupled to the body casing, connected to each of the purified water outlet flow path unit and the cold water outlet flow path unit, and provided with a drinking water outlet to allow the purified water and cold water to be discharged to the outside;
a descaling kit unit detachably coupled to the body casing so as to be replaceable with the water outlet unit and provided with an internal flow path to allow washing water to flow to the cold water outlet flow path unit, wherein the washing water is generated by dissolving a descaling material in the purified water introduced through the purified water outlet flow path unit; and
a control unit for controlling fluid flow in each of the units.

16. The water purifier according to claim 15, wherein the control unit controls the flow of the washing water so that the washing water sequentially passes through the cold water outlet flow path unit and the cold water generating unit.

17. The water purifier according to claim 16, wherein the cold water generating unit includes a second purified water inlet port connected to the purified water flow path unit, and a cold water outlet port connected to the cold water outlet flow path unit; and
the control unit controls the washing water to flow into the cold water outlet port and then flow out through the second purified water inlet port.

18. The water purifier according to claim 17, wherein the purified water flow path unit includes a second purified water flow path member connected to the second purified water inlet port, and
the second purified water flow path member is connected to a second branch flow path through which the washing water discharged to the second purified water inlet port flows.

19. The water purifier according to claim 16, wherein the control unit controls the flow of the washing water so that the washing water, which sequentially passes through the cold water outlet flow path unit and the cold water generating unit, is returned to the descaling kit unit via the purified water outlet flow path unit.

20. The water purifier according to claim 16, wherein the control unit controls the flow of the washing water so that the washing water, which passes sequentially through the cold water outlet flow path unit and the cold water generating unit and is then recovered to the descaling kit unit, is circulated repeatedly to remove scale.
